(19) United States
(12) Patent Application Publication
(10) Pub. No.: US 2020/0274714 A1
(43) Pub. Date: Aug. 27, 2020

(54) SYSTEM FOR, METHOD OF, AND SERVER COMPUTER SYSTEM FOR IMPLEMENTING TRANSFORMATION OF AN ORIGINAL ENTITY INTO A VERIFIABLY AUTHENTICABLE ENTITY IN A HETEROGENEOUS COMMUNICATIONS NETWORK ENVIRONMENT

(71) Applicant: Roberto Jesus Arriola Suson, Cebu City (PH)

(72) Inventor: Roberto Jesus Arriola Suson, Cebu City (PH)

(21) Appl. No.: 15/781,122

(22) PCT Filed: Jan. 29, 2018
(86) PCT No.: PCT/IB2018/050519

§ 371 Date: Jun. 2, 2018

(30) Foreign Application Priority Data
Jun. 2, 2017 (PH) PH12017000169
Jun. 2, 2017 (PH) PH22017050179

(51) Int. Cl. H04L 9/32; H04L 9/08; G06F 21/16

(52) U.S. Cl. CPC H04L 9/3239; H04L 9/3226; H04L 2209/38; G06F 21/16; H04L 9/0866

(57) ABSTRACT

Aspects of the present invention are directed to implementing transformation of an original entity into a verifiably authenticable entity in a heterogeneous communications network environment including at least a publisher computer, a server computer system, a customer computer, and a public record keeping system in a decentralized computational network which communicate with one another over a communications network such as the Internet. An electronic record of the original entity is created by the server computer system by associating a set of randomly produced unique identifiers to a physical indicia identifier which is extracted from an electronic file created by the publisher computer based on a digital reproduction of a portion of the original entity. A uniquely encrypted message associated with the electronic record of the original entity is published to a chain of data on a public record keeping system residing in nodes in a decentralized computational network which may be a Blockchain network. Verification of authenticity of an entity of interest relative to the original entity as a point of reference may include decrypting the uniquely encrypted message to identify whether a set of unique identifiers of interest associated with the entity of interest is published to the chain of data on the public record keeping system.

### CROSS-REFERENCE TO RELATED APPLICATIONS

NONE

### FEDERALLY SPONSORED RESEARCH

NOT APPLICABLE

### SEQUENCE LISTING OR PROGRAM

NOT APPLICABLE

### TECHNICAL FIELD

Embodiments and/or implementations of the present invention relates in general to verification of authenticity of an original entity but more particularly to system for, method of, and server computer system for implementing transformation of an original entity into a verifiably authenticable entity in a heterogeneous communications network environment.

### BACKGROUND ART

Authentication of various entities including physical objects, notably those which are valuable, has been well known to be applicably effective in many circumstances. One of which is the identification of whether an object, such as a painting, is an original work of art by an artist or is otherwise a reproduction by somebody else. Another is the identification of whether a valuable document, such as property title, is authentically issued by authorities or is appearing as an unlawfully fabricated one. Yet, and still, another well known application of entity authentication is in the conditional access and security systems where access to a secure facility for example, or to a secure electronic database, requires providing of pre-authorized credentials such as usernames and passwords.

The most common electronic method of transforming an original entity into an entity which can be authenticated through multi-step verification methods, systems and/or schemes appears to be the hash-based transformation method. In one instance, in U.S. Pat. No. 9,619,706 which was published on 11 Apr. 2017 to Enceladus IP Holdings, LLC and which is expressly incorporated herein by reference in its entirety and for all purposes, there is disclosed a communications network (e.g., Internet) connected central authentication server which applies a hash function to produce digitally signed serial number that can be imprinted on an object as a textual component, and that can be used to verify the authenticity of the object, wherein the serial number may be printed as a bar code rather than as readable text.

A primary technical problem associated with the above cited example of merely relying on hash-based transformations for authentication tasks in a communications network environment is that hash functions which are built, shared, and/or passed from one location to another in such a network based environment are vulnerable to length extension attacks given the premise that network-based connections from one computer to another may be intercepted and even redirected elsewhere in the communications network. In a successfully executed length extension attack, a known encrypted message may be controlled by attackers (e.g., by means of introducing to the message additional information which may affect the integrity of the original information associated with the message) by way of constructing and appending to it a valid signature without necessarily finding out the secret keys used to generate the original signature associated with it.

Moreover, the use of hash-based transformations, no matter how complex they may seem nowadays, in authentication tasks does not provide for a clear, secure, traceable and verifiably authenticable chain of evidence which is crucial in many situations. For one, reviewing an insurance claim, which formally requests an insurance company to issue a policy holder a certain amount of payment based on the terms of the policy, requires a chain of evidence that would support the claim. This chain of evidence is also crucial to fair and just prosecution of accused individuals in various court cases including criminal cases for example.

Further, it should be borne in mind that a hash-based transformation is a multi-step procedure. This generally means that any digitally signed serial number generated by way of using a hash-based transformation, as in the case of the above-cited prior art reference, may be altered, change, or modified before it gets imprinted on an object as a textual component. This specifically means that a hash-based transformation, all by itself, has a cycle latency or the number of completed cycles of conversion of data to produce an output data, such as the digitally signed serial number, from an input data that are subjected to data processing procedures. During the completion of each of such cycles, it may be possible to electronically alter, change, or modify the output data.

In view of the foregoing, there remains an outstanding need for ensuring that integrity of data or information associated with encrypted messages in implementing transformation of an original entity into a verifiably authenticable entity, most especially in a network-based environment, is uncompromised even in cases where attackers have already gained control of the encrypted messages, for providing a secure, traceable and verifiably authenticable chain of evidence in such implementation, and for ensuring security of data associated with the process of generating digitally signed serial numbers and forming the same on an object or entity with zero-cycle latency also in such implementation.

### SUMMARY OF THE INVENTION

Aspects of the invention are directed to implementing transformation of an original entity into a verifiably authenticable entity in a heterogeneous communications network environment including at least a publisher computer, a server computer system, a customer computer, and a public record keeping system in a decentralized computational network communicating with one another over a communications network such as the Internet.

An electronic record of the original entity is created by the server computer system by associating a set of randomly produced unique identifiers to a physical indicia identifier which is extracted from an electronic file created by the publisher computer based on a digital reproduction of a portion of the original entity.

A uniquely encrypted message associated with the electronic record of the original entity is published to a chain of data on a public record keeping system residing in nodes in a decentralized computational network which may be a Blockchain network.

Verification of authenticity of an entity of interest relative to the original entity as a reference point may include decrypting the uniquely encrypted message to identify whether a set of unique identifiers of interest associated with the entity of interest is published to the chain of data on the public record keeping system.

The provisions of the publishing of the uniquely encrypted message, which effectively carries the associated set of unique identifiers and the physical indicia identifier extracted from the electronic file created by the publisher computer based on the digital reproduction of a portion of the original entity, on the public record keeping system, and verifying the authenticity of an entity of interest relative to the original entity as a reference point by way of decrypting this uniquely encrypted message to identify whether a set of unique identifiers of interest associated with the entity of interest is published to the chain of data on the public record keeping system provide for: (i) cross checking by any of the nodes in the Blockchain network that the uniquely encrypted message is associated with its real publisher which results in the transparency in the ownership of the uniquely encrypted message and in turn of the original entity; and (ii) preservation of integrity of data associated with the uniquely encrypted message since any single change made against the string of characters in the uniquely encrypted message on the public record keeping system effectively changes its digital signature and such change, if it would occur at any point, can be easily and speedily detected through the nodes which do not rely on a central repository of data nor on a central server computer system, which usually comes in a significant number, which are distributed across the world via a network of private computers and computer systems, and which may individually possess a copy of the uniquely encrypted message.

In some embodiments, and consistent with one or more aspects of the invention, the set of unique identifiers is already available for selection from a pool of sets of unique identifiers which are pre-generated by the server computer system and pre-stored in the memory system of the server computer system before the electronic file of the digital reproduction of the original entity is received by the server computer system, before the associating of the set of unique identifiers to the extracted physical indicia identifier is initiated, and/or before the electronic record of the original entity is created. The availability of the set of unique identifiers for selection from the pool of sets of unique identifiers before executing these procedures effectively ensures that cycle latency in executing these procedures is zero or, where the occurrence of cycle latency cannot be prevented, is substantially reduced to a negligible level, and causes the chain of evidence to be of provable character from the point of inception characterized by the delivering of the digital reproduction of the original entity from the publisher computer to the server computer system over the communications network up to the point of forming the set of unique identifiers on the original entity and/or up to the point of publishing the uniquely encrypted message containing the set of unique identifiers to the chain of data in the publicly distributed record keeping system in the decentralized network.

In some embodiments, and consistent with one or more aspects of the invention, the zero-cycle latency may also be ensured by way of providing a parallel processing, by the server computer system, of a step of associating the set of unique identifiers to the extracted physical indicia identifier to create the electronic record of the original entity and a step of causing to be published the uniquely encrypted message to the chain of data on the public record keeping system. The actual publication of the uniquely encrypted message on the public record keeping system may be performed, by any one or more of the nodes in the decentralized computational network, at the moment the uniquely encrypted message reaches the location of the public record keeping system in the decentralized network.

In some embodiments, and consistent with one or more aspects of the invention, each and every step of the herein disclosed method and its associated processes and procedures are electronically recorded in the memory system of the server computer system and/or may be caused by the server computer system to undergo encryption and consequently be included in the uniquely encrypted message for publication to the chain of data in the publicly distributed record keeping system. This arrangement provides for a clear, secure, traceable and verifiably authenticable chain of evidence in the implementation of the transformation of the original entity into a verifiably authenticable entity.

For a better understanding of the invention and to show how the same may be performed, preferred embodiments and/or implementations thereof will now be described, by way of non-limiting examples only, with reference to the accompanying drawings and/or illustrations of the present disclosures.

### BRIEF DESCRIPTION OF THE SEVERAL VIEWS OF THE DRAWINGS

FIG. 1 is a block diagram illustrating a system for implementing transformation of an original entity into a verifiably authenticable entity in a heterogeneous communications network environment of the invention.

FIG. 2 is a flow diagram illustrating an exemplary operation of a method of implementing transformation of an original entity into a verifiably authenticable entity in a heterogeneous communications network environment consistent with one or more aspects of the invention.

FIG. 3 is a flow diagram illustrating another exemplary operation of a method of implementing transformation of an original entity into a verifiably authenticable entity in a heterogeneous communications network environment consistent with one or more aspects of the invention.

FIG. 4 is a flow diagram illustrating yet another exemplary operation of a method of implementing transformation of an original entity into a verifiably authenticable entity in a heterogeneous communications network environment consistent with one or more aspects of the invention.

FIG. 5 is a block diagram illustrating exemplary computer-based architecture for using unique identifiers in implementing transformation of an original entity into a verifiably authenticable entity consistent with one or more aspects of the invention.

FIG. 6 is a detailed block diagram illustrating exemplary components of the system for implementing transformation of an original entity into a verifiably authenticable entity consistent with one or more aspects of the invention.

FIG. 7 is a block diagram illustrating exemplary components of a public record keeping system located in a decentralized computational network which can be used for implementing transformation of an original entity into a verifiably authenticable entity consistent with one or more aspects of the invention.

FIG. 8 is a flow diagram illustrating an example verification process suitable for use in one or more aspects of the invention.

FIG. 9 is a flow diagram illustrating an example risk management process suitable for use in one or more aspects of the invention.

FIGS. 10 and 11 are high level block diagrams collectively illustrating an exemplary process for generating and an exemplary process for decrypting a uniquely encrypted message, respectively, suitable for use in one or more aspects of the invention.

FIG. 12 is a block diagram illustrating exemplary components of a payment network suitable for use in implementing transformation of an original entity into a verifiably authenticable entity consistent with one or more aspects of the invention.

FIG. 13 is a block diagram illustrating exemplary information associated with verification and authentication processes suitable for use in implementing transformation of an original entity into a verifiably authenticable entity consistent with one or more aspects of the invention.

FIG. 14 is a schematic block diagram illustrating an exemplary hardware configuration of a server computer system suitable for use in implementing transformation of an original entity into a verifiably authenticable entity consistent with one or more aspects of the invention.

FIG. 15 is a block diagram illustrating exemplary computer-based modules of a server computer system suitable for use in implementing transformation of an original entity into a verifiably authenticable entity consistent with one or more aspects of the invention.

FIG. 16 is a schematic block diagram illustrating an exemplary hardware configuration of a publisher computer or a customer computer suitable for use in implementing transformation of an original entity into a verifiably authenticable entity consistent with one or more aspects of the invention.

### DETAILED DESCRIPTION OF THE PREFERRED EMBODIMENTS

In the following description, numerous specific details such as components, method-steps or process-steps, elements, features, and techniques, are set forth in order to provide a thorough understanding of the ensuing disclosures and how they may be practiced in particular embodiments. However, it will be appreciated by a person skilled or having ordinary skills in the art to which the present invention belongs that the present disclosures may be practiced without these specific details. In other instances, well-known features, characteristics, methods, structures and techniques have not been shown in detail in order not to obscure an understanding of the ensuing disclosures.

References to “an embodiment,” “one embodiment,” “exemplary embodiment,” “example embodiment,” “various embodiments,” and so forth indicate that the embodiment(s) of the present disclosure so described may include a particular feature, characteristic, method, structure, or technique, but not every embodiment necessarily includes the particular feature, characteristic, method, structure, or technique. Further, repeated use of these phrases relating to one or more embodiments of the present invention do not necessarily refer to the same embodiment, although they may.

As may be used herein, unless otherwise specified, the term “entity” may refer to, by way of examples and not by way of limitation, and consistent with one or more aspects of the present invention, a physical object such as document or a painting, a digital object such as an electronic database or any similar data storage structure, a human, a microscopic organism, a genetic sequence, a physical structure in an environment such as a research facility or a hospital structure, an animal such as a lion or a dog, a plant such as a bamboo, a tangible asset such as a car, a physical characterization of a tangible asset such as a Transfer Certificate Title or a Condominium Certificate of Title, a physical characterization of an intangible asset such as a Certificate of Letters Patent, a Certificate of Trademark Registration or an insurance policy and related contractual agreements, and a celestial body such as a satellite or a spacecraft. It is to be understood and appreciated that anything in the universe whose authenticity is feasibly verifiable, and/or worth verifying, mostly due to its economic, social, moral and/or legal related values, or otherwise, may be referred to as the “entity” in the ensuing disclosures of one or more aspects of the present invention.

As may be used herein, unless otherwise specified, the terms “physical indicia identifier” may refer to any form of markings that can be placed upon any entity. The physical indicia identifier may be visually perceptible (e.g., by using markings which are visible by unaided human eyes or by humans eyes aided by standard corrective lenses), tactilely perceptible (e.g., by using tactilely or touchably perceptible embossment-like structure, gripping-like structure, raised formation-like structure, or the like), readable by machine (e.g., by using barcode, quick-response code, or the like), and/or any one or more suitable combinations thereof. The physical indicia identifier may alternatively be the entire document itself, or any security marking, or any security feature appended thereto. The herein disclosed physical indicia identifier may be an image feature data, either directly taken using an image capturing apparatus such as a stand-alone camera unit or a device-mounted camera unit (e.g., mobile phone mounted camera unit) or indirectly taken using a video recording apparatus. These image feature data which may be extracted from one or more portions/regions of any entity may include, but are certainly not limited to, color histogram, shape identification, pattern identification, texture identification, dominant color identification, and/or orientation histogram corresponding to an image of the entity, or any other physical characteristic that is descriptive of the entity in part or as a whole.

The herein disclosed server computer system may perform extraction of any one or more of these example image feature data using technologies which are well known and/or are being practiced in the art, such as those which are disclosed in U.S. Pat. No. 7,657,100 entitled “System and method for enabling image recognition and searching of images and published on 2 Feb. 2010 to Like.com, and in United States Patent Publication No. 20140056487 entitled “Image processing device and image processing method” and published on 27 Feb. 2014 to Fujitsu Limited, the full content of each of which is incorporated herein by reference in its entirety and for all purposes.

As may be used herein, unless otherwise specified, the terms “set of unique identifiers” may refer to a string or multiple strings of letters, a string or multiple strings of numbers, a string or multiple strings of alphanumeric characters, a string or multiple strings of alphanumeric codes in any format or language, or the like. These strings of values may be generic attribute values which can be used to identify, verify, track, trace, and/or authenticate an entity. Forming of the set of unique identifiers on the entity, or on any one or more portions thereof, may be machine or apparatus assisted.

As may be used herein, unless otherwise specified, the terms “public record keeping system” may refer to combinations of hardware and software systems which provide distributed data structure in a decentralized computing framework and which support various computational functions which may include distributing computational tasks such as validating transaction ownership, verification of authenticity of an entity, and managing transaction risk from one or more computer systems to one or more other computer systems in a distributed network. These computer systems in the distributed record keeping system may also be characterized by a peer-to-peer network of computers or computer systems. Public, private, or a hybrid of public and private record keeping systems included in the distributed record keeping system may include blocks containing data which may be represented by encryptions and/or encrypted messages, linking data which are arranged to link a current block to a previous block in a chain of the blocks provided with encryptions and/or encrypted messages, data recording and tracking system for ensuring validity of the transactions, which may include the encryption, performed through the chain of the blocks with proof of work data. Cryptography, such as by way of implementing digital signatures, may be used to protect the computational environment which characterizes the distributed record keeping system and to provide the distributed record keeping system with audit logs that are verifiable, sealable and/or redactable. By way of encrypting electronic records using such digital signatures which may include the step of convolving the encryptions and/or encrypted messages with known keys, the chronological order of the blocks in the chain can be identifiable and traceable without complexities in operation, and integrity of the data associated with any uniquely encrypted message and/or any verification-related messages can be arranged such that they are independently verifiable by each node in the distributed network on which the distributed record keeping system resides.

As may be used herein, the terms “biometric information” may refer to any information which are related to human characteristics. These biometric information may be derived from any single-modal or multi-modal biometric identification or sensing mechanisms which may involve use of camera, microphone, or other devices of the same nature or general characteristics. A biometric sensor in one instance, may include, by way of examples and not by way of limitation, face sensors for facial attribute recognition, speech sensors for speech recognition, optical measurement based sensors for iris pattern recognition, corneal pattern recognition and retinal scan, and as well as fingerprint sensors for fingerprint scan. The biometric sensor may also include palm sensors for palm vein pattern recognition, hand sensors for hand geometry recognition, and handwriting sensors for signature recognition. It is to be understood and appreciated that biometric measurements of any of other body features of a user may also be utilized in the herein disclosed one or more aspects of the present invention. The biometric information captured by these and such other related sensors may generally correspond to the identifying characteristics of the individual human users. Put differently, these characteristics can be utilized to identify, verify and/or authenticate identity and/or personal information of individual human users. Any one or suitable combinations of the aforementioned biometric information and/or captured biometric keys associated with these information, in part, or as a whole, or in conjunction with any of the herein disclosed indicia identifier and unique identifiers, may be utilized in one or more aspects of the present invention.

As may be used herein, unless otherwise specified, the term “node” may be a stand-alone device, a distributed device, a remotely operable device, or a cluster of distributed and decentralized devices. The node may be made operable to perform computations and as well as acquisitions of data from and/or transmission of data to another computing devices such as server devices, transaction devices, and other hardware components. The node may be or may include a micro-controller, a single central processing unit (CPU), a plurality of processing units, a digital signal processor (DSP), a single computing system, or a cluster of computing systems. The node may include a communication module that communicates with wired or wireless data and/or radio communication networks. The node may be operated by each participating entity in the distributed network. The participating entity operating the node may be any entity as defined herein.

As may be used herein, unless otherwise specified, the terms “communications network” may refer to any number of communication systems which may include a plurality of the transaction devices, a plurality of the server devices or systems, and a plurality of the nodes preferably adapted for wireless communications with one another. For example, the data communications network may refer to any number of data communications systems including one or more of the following communications networks and/or frameworks: a public or private data network, a hybrid public and private data network, a wired or wireless data network, an IP (Internet Protocol) framework, a WLAN (wireless local area network), a WWAN (wireless wide area network), a GAN (global area network), a MAN (metropolitan area network), an LTE (Long Term Evolution) network of any generation, a mobile WiMax (worldwide interoperability for microwave access) network, an enterprise intranet, the like, and/or, where feasible, any one or more suitable combinations thereof.

As may be used herein, unless otherwise specified, the terms “marking apparatus,” consistent with one or more aspect of the present invention, may be any of a 2D (two-dimensional) printing apparatus, a 3D (three-dimensional) printing apparatus, a punch press apparatus, a laser processing apparatus, an ultra violet laser marking apparatus, a plasma processing apparatus, a label applying apparatus, a screen printing apparatus, an etching apparatus, a cutting apparatus, a stamping apparatus, a pad printing apparatus, an engraving apparatus, a grinding apparatus, an annealing apparatus, a casting apparatus, a microdot marking apparatus, a chemical based marking apparatus, a nanotechnology-based marking apparatus, a DNA (deoxyribonucleic acid) forensic marking apparatus, and a biometric information based marking apparatus, depending on the nature and physical character of the entity whose authenticity is to be verified, checked and/or determined.

As may be used herein, unless otherwise specified, the terms “server computer system” may refer to a collection of one or more hardware, software, combinations of hardware and software, or firmware components, and may be used to refer to an electronic computing device or devices, or one or more subsystems thereof, within which one or more sets of computer-executable instructions, which are tangibly embodied in one or more machine-readable media, may be executed by the hardware components in order to perform arithmetic operations, logical operations, timing operations, and specialized functions applicable to specific task objects and consequently produce control outputs and/or control signals associated with the present invention in accordance with one or more implementations and/or embodiments thereof.

As may be used herein, the terms “software application,” may refer to emulated application or applet, to a web-based applications, or to a mobile-based application, and may specifically refer to an executable computer software program or software application program that enables services and content associated with one or more implementations of the herein disclosed method of implementing transformation of an original entity into a verifiably authenticable entity in a heterogeneous communications network environment. The application may be a mobile app or any other application that is executable via any one or more of client-side devices including a publisher computer or a customer computer, via a server, or via a network of computers. The program or programs which may constitute the application may be a self-contained software or is a component of or contained by another program or programs, any of which may be implemented by one or more hardware, software, firmware and/or cloud computing or cloud related computing resources comprising one or more infrastructure stacks and one or more infrastructure components such as application servers, file servers, DNS (domain name system) servers, directory servers, web servers, network servers, group servers, database servers, and the like.

As may be used herein, unless otherwise specified, the terms “publisher computer” or “customer computer” may refer to a wireless mobile or non-mobile data communication device such as a mobile phone, a smart-phone, a personal digital assistant (PDA) device, a tablet device, a phablet device, a desktop computer, a laptop computer, and the like. The publisher computer or the customer computer may be connected to the herein disclosed communications network and may access the herein disclosed server computer system for performing various operations such as those which are associated with verification of authenticity of an original entity. The publisher computer or the customer computer may be used by a human client to gain access to the herein disclosed authenticity verification services of the present invention.

As may further be used herein, unless otherwise specified, the terms “connected to,” “connecting,” “communicating,” “in communication with,” “in operative communication with,” “interconnected,” or “interconnecting” may include direct connection/communication, indirect connection/communication and/or inferred connection/communication between devices/apparatuses/computers. The direct connection/communication may be provided through one or more hardware, software, firmware, electronic and/or electrical links between devices/apparatuses. The indirect connection/communication may be provided through an intervening member such as a component, an element, a circuit, a module, a device, a node device, and an apparatus between or among devices/apparatuses. The inferred connection/communication, as may be used herein, may be characterized by one device/apparatus being connected to or in operative communication with another device/apparatus by inference, and may include direct and indirect connections/communications.

All the ensuing disclosures and illustrations of the preferred implementations and/or embodiments of one or more aspects of the present invention, along with one or more components, features or elements thereof, are merely representative for the purpose of sufficiently describing the manner by which the present invention may be carried out into practice in various ways other than the ones outlined in the ensuing description.

It is to be understood and appreciated, however, that the exemplary implementations used to describe how to make and use the one or more aspects of the present invention may be embodied in many alternative forms and should not be construed as limiting the scope of the appended claims in any manner, absent express recitation of those features in the appended claims. All the exemplary drawings, diagrams and illustrations accompanying the ensuing description should also not be construed as limiting the scope of the appended claims in any manner.

It is also to be understood and appreciated that the use of ordinal terms such as “first” and “second” is used herein to distinguish elements, features, components, calculations or steps from one another and should not also be construed as limiting the scope of the appended claims, and that these and such other ordinal terms that may appear in the ensuing description of the one or more aspects of the present invention are not indicative of any particular order of elements, features, calculations, components or steps to which they are attached. For example, a first element could be termed a second element. Similarly, a second element could be termed a first element. All these do not depart from the scope of the herein disclosure and its accompanying claims.

Unless the context clearly and explicitly indicates otherwise, it is also to be understood that like reference numerals refer to like elements throughout the ensuing description of the figures and/or drawings of the present disclosure, that the linking term “and/or” includes any and all combinations of one or more of the associated listed items, that the singular terms “a”, “an” and “the” are intended to also include the plural forms, and that some varying terms or terminologies of the same meaning and objective may be interchangeably used throughout the ensuing disclosure.

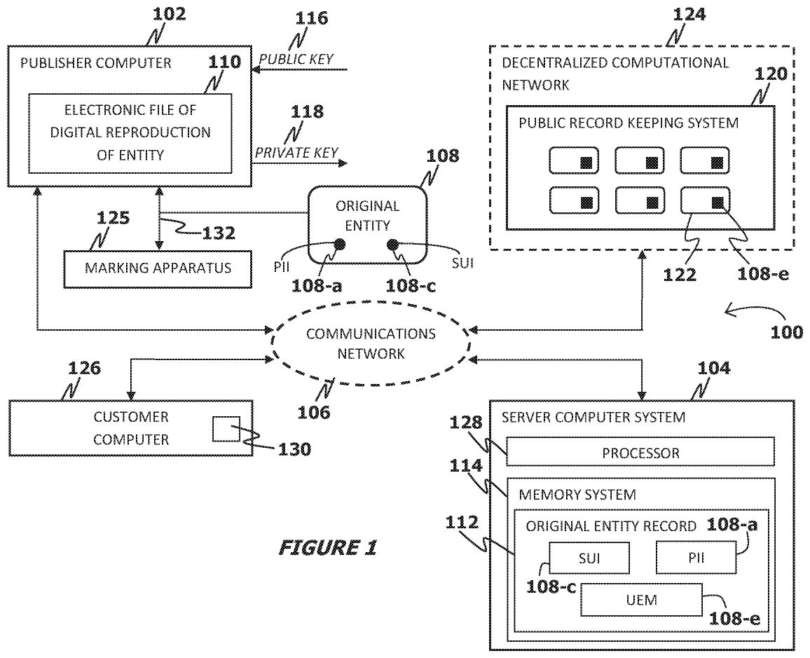

Referring now to FIG. 1, there is shown a block diagram which illustrates a system for implementing transformation of an original entity into a verifiably authenticable entity in a heterogeneous communications network environment of the present invention. The system aspect of the present invention is generally designated by reference numeral 100 throughout the ensuing description and/or illustration of the present disclosure. The system 100 mainly includes a publisher computer 102 in operative communication with a server computer system 104 over a communications network 106 such as the Internet.

The publisher computer 102 is preferably arranged to: (i) obtain a digital reproduction of at least one portion of the original entity 108 on which at least one physical indicia identifier or “PII” 108-a may be appearing; (ii) create an electronic file 110 of the digital reproduction of the at least one portion of the original entity 108; and (iii) deliver, over the communications network 106, to the server computer system 104 the electronic file 110.

The server computer system 104 is preferably arranged and/or configured to: (i) extract the at least one physical indicia identifier 108-a from the electronic file 110; (ii) associate a set of unique identifiers or “SUI” 108-c to the extracted at least one physical indicia identifier 108-a to create an electronic record 112 of the original entity 108; and (iii) store in a memory system 114 of the server computer system 104 the electronic record 112 of the original entity 108 having the associated set of unique identifiers 108-c and at least one physical indicia identifier 108-a.

The server computer system 104 may be further arranged and/or configured to: (iv) encrypt the electronic record 112 of the original entity 108 using a public key 116 associated with the publisher computer 102 and a digital signature including a private key 118 associated with the publisher computer 102 to generate a uniquely encrypted message or “UEM” 108-e carrying the associated set of unique identifiers 108-c and at least one physical indicia identifier 108-a; (v) publish, over the communications network 106, the uniquely encrypted message 108-e to a chain of data on a public record keeping system 120 residing in one or more nodes 122 in a decentralized computational network 124 using at least one decentralized computational network protocol; and (vi) subsequently send, over the communications network 106, to the publisher computer 102 the set of unique identifiers 108-c.

The system 100 may also include a marking apparatus 125 operatively coupled to the publisher computer 102 through any appropriate communication bus and/or circuitries 132. The marking apparatus 125 is preferably arranged to form the set of unique identifiers 108-c on any portion of the original entity 108.

The system 100 may also include a customer computer 126 accessing the server computer system 104 over the communications network 106. By means of which, a customer who is operating the customer computer 126 is enabled to verify whether an entity of interest is authentic relative to the original entity 108 as a point of reference or reference point.

In one embodiment, the server computer system 104 may be further arranged and/or configured to: (i) accept from the customer computer 126 a set of unique identifiers of interest formed on the entity of interest having at least one physical indicia identifier of interest; and (ii) determine whether the set of unique identifiers of interest and the at least one physical indicia identifier of interest are associated with one another and exist in the memory system 114 of the server computer system 104.

Consequently, the server computer system 104 can be further arranged and/or configured to: (iii) if the set of unique identifiers of interest and the at least one physical indicia identifier of interest are associated with one another and exist in the memory system 114 of the server computer system 104, fetch from the memory system 114 of the server computer system 104 the electronic record of 112 the original entity 108 corresponding to the associated set of unique identifiers of interest and at least one physical indicia identifier of interest existing in the memory system 114 of the server computer system 104. Any one or more of the tasks in the server computer system 104, including the fetching step for example, may be executed by a processor 128 from the memory system 114 of the server computer system 104.

Accordingly, the server computer system 104 can be further arranged and/or configured to: (iv) communicate, over the communications network 106, with the decentralized computational network 124 using the at least one decentralized computational network protocol; and (v) identify, as one of the one or more nodes 122 in the decentralized computational network 124, whether the set of unique identifiers of interest carried by the uniquely encrypted message 108-e is published to the chain of data on the public record keeping system 120 by decrypting the uniquely encrypted message 108-e associated with the fetched electronic record 112 of the original entity 108 using the public key 116 associated with the publisher computer 102 which causes creation of the fetched electronic record 112 of the original entity 108 in the memory system 114 of the server computer system 104 of the one or more aspects of the present invention.

Accordingly, the server computer system 104 can be further arranged and/or configured to: (vi) if the at least set of unique identifiers of interest is recorded in the chain of data, acquire from the memory system 114 of the server computer system 104 in whole or in part the electronic file 110 of the digital reproduction of the at least one portion of the original entity 108 based on the associated set of the unique identifiers of interest and physical indicia identifier of interest; and (vii) transmit, over the communications network 106, to the customer computer 126 the acquired electronic file 110 of the digital reproduction of the at least one portion of the original entity 108.

In one embodiment, the customer computer 126 which may be operated by a human user may be arranged and/or configured to: (i) receive, over the communications network 106, the transmitted digital reproduction of the at least one portion of the original entity 108 associated with acquired electronic file 110 from the server computer system 104; and (ii) output on an output unit 130 of the customer computer 126 the received digital reproduction of the at least one portion of the original entity 108.

In one embodiment, and consistent with one or more aspects of the present invention, the electronic file 110 of the digital reproduction of the original entity 108 may also be provided with the set of unique identifiers 108-c. Specifically, the set of unique identifiers 108-c may be provided on any portion of the digital reproduction of the original entity 108. The digital reproduction of the original entity 108 with the set of unique identifiers 108-c provided thereon may be stored in the memory system 114 of the server computer system 104. Accordingly, the position of the set of unique identifiers 108-c on the original entity 108 may be the same as, or otherwise different from, the position of the set of unique identifiers 108-c on the digital reproduction of the original entity 108 arranged as the electronic file 110.

In various embodiments, and consistent with one or more aspects of the present invention, where applicable, the server computer system 104 may be arranged to generate a printable digital certification containing statements to the effect that the authenticated copy of the original entity 108 has been stored in the memory system 114 of the server computer system 104, to the effect that the uniquely encrypted message 108-e associated with the original entity 108 of verifiably authenticable character has been published to the chain of data on the public record keeping system 120 residing in the one or more nodes 122 in the decentralized computational network 124, and/or to the effect that the chain of evidence of valid ownership and/or authenticated originality of the original entity 108 is verifiable via the decentralized computational network 124 which may be a Blockchain network using any suitable protocol. Given that this kind of certification, which may include a digital certified true copy of the original entity 108, can be generated by the server computer system 104 and provided to any requesting computer in an on-demand manner, an anti-collusion instrument in respect of the valid facts pertaining to the original entity 108 is permanently created.

In some embodiments, and consistent with one or more aspects of the present invention, the set of unique identifiers 108-c is already available for selection from a pool of sets of unique identifiers 108-c which are pre-stored in the memory system 114 of the server computer system 104 before the electronic file 110 of the digital reproduction of the original entity 108 is received by the server computer system 104, before the associating of the set of unique identifiers 108-c to the extracted physical indicia identifier 108-a is initiated, and/or before the electronic record 112 of the original entity 108 is created. The availability of the set of unique identifiers 108-c for selection from the pool of sets of unique identifiers 108-c before executing these procedures effectively ensures that cycle latency in executing these procedures is zero or, where the occurrence of cycle latency cannot be prevented, is substantially reduced to a negligible level, and causes the chain of evidence to be of provable character from the point of inception characterized by the delivering of the digital reproduction of the original entity 108 from the publisher computer 102 to the server computer system 104 over the communications network 106 up to the point of forming the set of unique identifiers 108-c on the original entity 108 and/or up to the point of publishing the uniquely encrypted message 108-e containing the set of unique identifiers 106-c to the chain of data on the publicly distributed record keeping system 120 in the decentralized network 124.

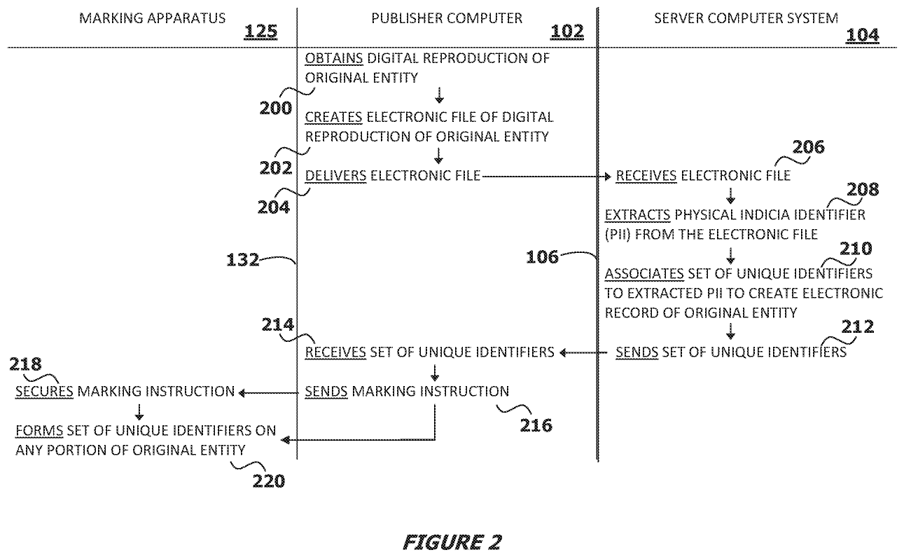

Referring now to FIG. 2, there is shown a flow diagram which illustrates an exemplary operation of a method of implementing transformation of the original entity 108 into a verifiably authenticable entity in the heterogeneous communications network environment consistent with one or more aspects of the present invention. The method aspect of the present invention may be performed using computer or computer related operations associated with the hardware and/or software components of the system illustrated in greater detail in FIG. 1.

The first step of the exemplary operation of the herein disclosed method may be characterized by obtaining, by the publisher computer 102, a digital reproduction of at least one portion of the original entity 108 on which the at least one physical indicia identifier 108-a is appearing (step 200).

The second step of the exemplary operation of the herein disclosed method may be characterized by creating, by the publisher computer 102, the electronic file 110 of the digital reproduction of the at least one portion of the original entity 108 (step 202).

The third step of the exemplary operation of the herein disclosed method may be characterized by delivering, by the publisher computer 102 in operative communication with the server computer system 104 over a communications network 106, to the server computer system 104 the electronic file 110 (step 204). This, in turn, causes the server computer system 104 to receive the electronic file 110 from the publisher computer 102 over the communications network 106 (step 206).

The fourth step of the exemplary operation of the herein disclosed method may be characterized by extracting, by the server computer system 104, the at least one physical indicia identifier 108-a from the electronic file 110 (step 208).

The fifth step of the exemplary operation of the herein disclosed method may be characterized by associating, by the server computer system 104, the set of unique identifiers 108-c to the extracted at least one physical indicia identifier 108-a to create the electronic record 112 of the original entity 108 (step 210).

The sixth step of the exemplary operation of the herein disclosed method may be characterized by sending, by the server computer system 104 over the communications network 106, to the publisher computer 102 the set of unique identifiers 108-c (step 212). This, in turn, causes the publisher computer 102 to receive the set of unique identifiers 108-c from the server computer system 104 over the communications network 106 (step 214).

The seventh step of the exemplary operation of the herein disclosed method may be characterized by forming, by the marking apparatus 125 operatively coupled to the publisher computer 102, the set of unique identifiers 108-c on any portion of the original entity 108 (step 220).

The forming step (i.e., step 220) may include the intervening steps of sending by the publisher computer 102 to the marking apparatus 125 at least one computer-executable marking instruction (step 216), and then securing, by the marking apparatus 125, the marking instruction from the publisher computer 102 (step 218), wherein all these may be performed through any appropriate circuitries 132. Simply put, the marking instruction may be secured by the marking apparatus 125 from the publisher computer 102 through the circuitries 132.

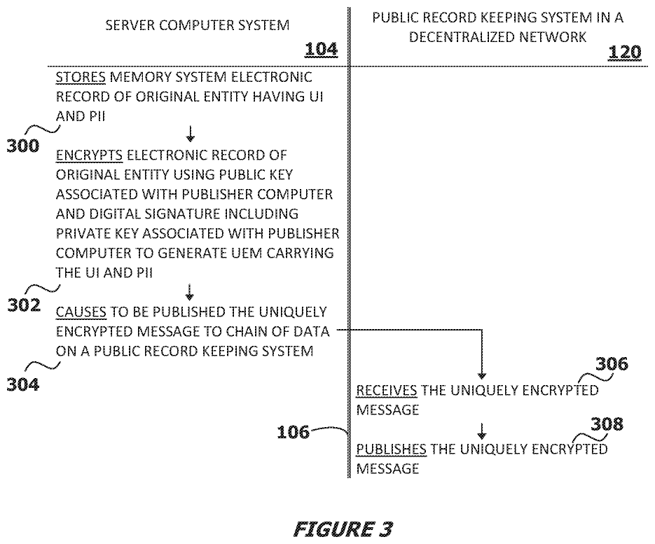

Referring now to FIG. 3, there is shown a flow diagram which illustrates another exemplary operation of a method of implementing transformation of the original entity 108 into a verifiably authenticable entity in a heterogeneous communications network environment consistent with one or more aspects of the present invention, and which may be a continuation or may form part of the exemplary operation illustrated in FIG. 2.

The first step of the another exemplary operation of the herein disclosed method which is associated with the associating step (i.e., step 210) may be characterized by storing, by the server computer system 104, in the memory system 114 of the server computer system 104 the electronic record 112 of the original entity 108 having the associated set of unique identifiers 108-c and at least one physical indicia identifier 108-a (step 300).

The second step of the another exemplary operation of the herein disclosed method may be characterized by encrypting, by the server computer system 104, the electronic record 112 of the original entity 108 using the public key 116 associated with the publisher computer 102 and the digital signature including the private key 118 associated with the publisher computer 102 to generate the uniquely encrypted message 108-e carrying the associated set of unique identifiers 108-c and at least one physical indicia identifier 108-a (step 302).

The third step of the another exemplary operation of the herein disclosed method may be characterized by causing, by the server computer system 104 over the communications network 106, to be published the uniquely encrypted message 108-e to the chain of data on the public record keeping system 120 residing in the one or more nodes 122 in the decentralized computational network 124 using the at least one decentralized computational network protocol (step 304). This, in turn, may cause the public or publicly distributed record keeping system 120 to receive and subsequently publish to the chain of data located thereon the uniquely encrypted message 108-e (steps 306, 308).

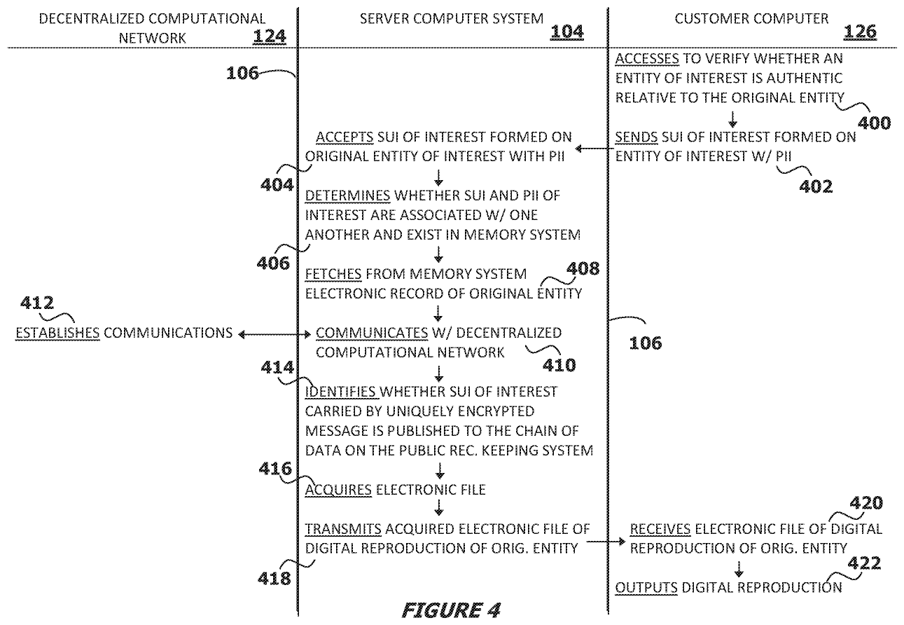

Referring to FIG. 4, there is shown a flow diagram which illustrates yet another exemplary operation of a method of implementing transformation of the original entity 108 into a verifiably authenticable entity in a heterogeneous communications network environment consistent with one or more aspects of the present invention, and which may be a continuation or may form part of the exemplary operation illustrated in FIG. 3.

The first step of the yet another exemplary operation of the herein disclosed method may be performed by the server computer system 104 when the customer computer 126 accesses the server computer system 104 over the communications network 106, and whereby a customer operating the customer computer 126 is enabled to verify whether an entity of interest is authentic relative to the original entity 108 as a point of reference (step 400). This, in turn, may cause the customer computer 126 to send to the server computer system 104 the set of unique identifiers of interest formed on the entity of the interest having, bearing, or containing the physical indicia identifier of the interest (step 402).

The second step of the yet another exemplary operation of the herein disclosed method may be characterized by accepting, by the server computer system 104, from the customer computer 126 the set of unique identifiers of interest formed on the entity of interest having the at least one physical indicia identifier of interest (step 404).

The third step of the yet another exemplary operation of the herein disclosed method may be characterized by determining, by the server computer system 104, whether the set of unique identifiers of interest and the at least one physical indicia identifier of interest are associated with one another and exist in the memory system 114 of the server computer system 104 (step 406).

The fourth step of the yet another exemplary operation of the herein disclosed method may be characterized by, if the set of unique identifiers of interest and the at least one physical indicia identifier of interest are associated with one another and exist in the memory system 114 of the server computer system 104, fetching, by the server computer system 104, from the memory system 114 of the server computer system 104 the electronic record 112 of the original entity 108 corresponding to the associated set of unique identifiers of interest and at least one physical indicia identifier of interest existing in the memory system 114 of the server computer system 104 (step 408).

The fifth step of the yet another exemplary operation of the herein disclosed method may be characterized by communicating, by the server computer system 104 over the communications network 106, with the decentralized computational network 124 using the at least one decentralized computational network protocol (step 410). This, in turn, causes the decentralized computational network 124 in which the public record keeping system 120 resides to establish data communications with the server computer system 104 over the communications network 106, that may be in real-time or near real-time (step 412).

The sixth step of the yet another exemplary operation of the herein disclosed method may be characterized by identifying, by the server computer system 104 as one of the one or more nodes 122 in the decentralized computational network 124, whether the set of unique identifiers of interest carried by the uniquely encrypted message 108-e is published to the chain of data on the public record keeping system 120 by decrypting the uniquely encrypted message 108-e associated with the fetched electronic record 112 of the original entity 108 using the public key 116 of the publisher computer 102 which causes creation of the fetched electronic record 112 of the original entity 108 (step 414).

The seventh step of the yet another exemplary operation of the herein disclosed method may be characterized by, if the at least set of unique identifiers of interest is recorded in the chain of data, acquiring, by the server computer system 104, from the memory system 114 of the server computer system 104 in whole or in part the electronic file 110 of the digital reproduction of the at least one portion of the original entity 108 based on the associated set of the unique identifiers of interest and physical indicia identifier of interest (step 416).

The eight step of the yet another exemplary operation of the herein disclosed method may be characterized by transmitting, by the server computer system 104, over the communications network 106, to the customer computer 126 the acquired electronic file 110 of the digital reproduction of the at least one portion of the original entity 108 (step 418).

The ninth step of the yet another exemplary operation of the herein disclosed method may be characterized by receiving, as performed by the customer computer 126 over the communications network 106, the transmitted digital reproduction of the at least one portion of the original entity 108 associated with acquired electronic file 110 from the server computer system 104 (step 420).

The tenth step of the yet another exemplary operation of the herein disclosed method may be characterized by outputting, as performed by the customer computer 126, on the output unit 130 of the customer computer 126 the received digital reproduction of the at least one portion of the original entity 108 (step 422).

In some embodiments, and consistent with one or more aspects of the present invention, the zero-cycle latency may also be ensured by way of providing a parallel processing, by the server computer system 104, of the step of associating the set of unique identifiers 108-c to the extracted physical indicia identifier 108-a to create the electronic record 112 of the original entity 108 (i.e., step 210) and the step of causing to be published the uniquely encrypted message 108-e to the chain of data on the public record keeping system 120 (i.e., step 304) in the network 124.

The actual publication of the uniquely encrypted message 104-e on the public record keeping system 120 may be performed, by any one or more of the nodes 122 in the decentralized computational network 124, at the moment the uniquely encrypted message 104-e reaches the location of the public record keeping system 120 in the network 124.

With this zero-cycle latency, any potential alteration, changes, or modifications made against the output data characterized by the set of unique identifiers 108-c to be formed on the original entity 108 will not affect the set of unique identifiers 108-c included in the uniquely encrypted message 108-e as the input data to be published on the public ledger system 120 in the decentralized computational network 124. This, in turn, may mean that the integrity of the published set of unique identifiers 108-c included in the uniquely encrypted message 108-e is preserved and/or remains uncompromised at all times.

In some embodiments, and consistent with one or more aspects of the present invention, each and every step of the herein disclosed method and its associated processes and procedures are electronically recorded in the memory system 114 of the server computer system 104 and/or may be caused by the server computer system 104 to undergo encryption and encrypted related procedures and consequently be included in the uniquely encrypted message 108-e for publication to the chain of data in the publicly distributed record keeping system 120. This arrangement provides for a clear, secure, traceable and verifiably authenticable chain of evidence in the implementation of the transformation of the original entity 108 into a verifiably authenticable entity.

In one embodiment, and consistent with one or more aspects of the present invention, the herein disclosed method may comprise the step of linking, by the server computer system 104, a first set of the unique identifiers 108-c associated with and generated for a first of the original entity 108 to a second set of the unique identifiers 108-c associated with and generated for a second of the original entity 108, wherein the first and second of the original entities 108 may be related with one another. It is to be understood and appreciated that the degree of relationship of the first and second of the original entities 108 may vary, or they may not be related at all. The latter case may mean that the linking step may be initiated by the server computer system 104 based on a request or an instruction from the user operating the publisher computer 102, wherein the request or instruction could be based on the personal preferences or choice of the user.

The linking step can be arranged such that: (i) the first of the original entity 108 is verifiably authenticable in accordance with any one or more of the aspects of the present invention using the second of the set of unique identifiers 108-c; (ii) the second of the original entity 108 is verifiably authenticable in accordance with any one or more of the aspects of the present invention using the first of the set of unique identifiers 108-c; (iii) the linked first and second of the set of unique identifiers 108-c may form part of one or more of the uniquely encrypted messages 108-e which may be published on the public record keeping system 120; (iv) digital objects and data structure associated with the linked first and second of the set of unique identifiers 108-c are referenced to one another; and (v) the first and second of the set of unique identifiers 108-c may be electronically stored and/or organized in one digital wallet which will be discussed in greater detail in the ensuing disclosure of the aspects of the present invention.

The interchangeable and/or interconnected manner of verifying whether the first of the original entity 108 is authentic relative to a first of the original entity of interest using the second of the set of unique identifiers 108-c and whether the second of the original entity 108 is authentic relative to a second of the original entity of interest using the first of the set of unique identifiers 108-c provides for an integrated verification and authentication structure for various original entities 108 which are related with one another by virtue of their similarity in features, geographic place of origin, shared characteristics, demographics, common association, authorities governing them, laws and implementing rules governing them, reciprocal alliance, occurrence during a common time period, or familial relationship, or by simply being deliberately grouped into a customizably named entity or “a collection of preferably related entities, items, or objects.”

For example, in a case where the original entity 108 is a passport, it is typically required to present and/or submit to the passport issuing authority a birth certificate and a national identification card. The passport may have its corresponding passport-attached set of unique identifiers 108-c; the birth certificate may have its corresponding birth certificate-attached set of unique identifiers 108-c; and the national identification card may have its corresponding identification card-attached set of unique identifiers 108-c. Given the fact that the birth certificate and the national identification card are typically required in securing a passport, it can be considered that they are linked to one another. Their respective sets of unique identifiers 108-c may then be linked together such that they are interchangeably verifiable in respect of one another. By that, it means that, in one instance, the authenticity of the passport may be determined by verifying whether the national identification card-attached set of unique identifiers 108-c or the birth certificate-attached set of unique identifiers 108-c exists in the memory system 114 of the server computer system 104 and/or on the public record keeping system 120 residing in the decentralized computational network 124.

Accordingly, and consistent with one or more aspects of the present invention, the linking step as disclosed herein may include causing, by the server computer system 104, de-linking of the first of the set of unique identifiers 108-c associated with and generated for the first of the original entity 108 from the second of the set of unique identifiers 108-c associated with and generated for the second of the original entity 108.

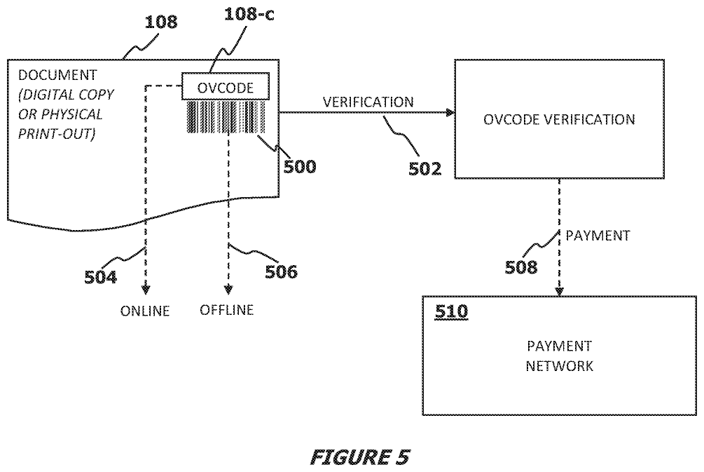

Referring to FIG. 5, there is shown a block diagram which illustrates exemplary computer-based architecture for using the unique identifiers 108-c in implementing transformation of the original entity 108 into a verifiably authenticable entity consistent with one or more aspects of the present invention. Consistent with any one or more of the herein disclosed aspects of the present invention, the entity 108 may be a physical, tangible document 108 on which the set of unique identifiers or “OVNUMBER” 108-c, which may be produced by the server computer system 104 in a random manner, can be made to appear by any of the herein disclosed means and/or computer related procedures.

Consistent with any one or more of the herein disclosed aspects of the present invention, the randomly produced set of unique numbers 108-c may be represented by a machine-readable data 500. The machine-readable data 500 can also be made to appear on the document type of original entity 108.

Consistent with any one or more of the herein disclosed aspects of the present invention, the machine-readable data 500 corresponding to the set of unique identifiers 108-c may be sent, over the communications network 106, from the server computer system 104 to the publisher computer 102, and may be formed, by the marking apparatus 125, on any suitable or preferred portion of the document type of original entity 108.

Consistent with one or more aspects of the present invention, the identifying step (i.e., step 414) may include identifying whether the at least one physical indicia identifier of interest carried by the uniquely encrypted message 108-e is published to the chain of data on the public record keeping system 120 by decrypting the uniquely encrypted message 108-e associated with the fetched electronic record 112 of the original entity 108 using the public key 116 associated with the publisher computer 102 which causes creation of the fetched electronic record 112 of the original entity 108.

Accordingly, and consistent with one or more aspects of the present invention, if the at least one physical indicia identifier of interest is recorded on the chain of data, the acquiring step (i.e., step 416) may include acquiring from the memory system 114 of the server computer system 104 in whole or in part the electronic file 110 of the digital reproduction of the at least one portion of the original entity 108 based on the associated set of the unique identifiers of interest and physical indicia identifier of interest.

Accordingly, and consistent with one or more aspects of the present invention, if the set of unique identifiers of interest is recorded in the chain of data, the acquiring step (i.e., step 416) may include comparing the at least one physical indicia identifier of interest with the at least one physical indicia identifier.

Accordingly, and consistent with one or more aspects of the present invention, if the set of unique identifiers of interest is recorded in the chain of data, the acquiring step (i.e., step 416) may include indicating whether the compared at least one physical indicia identifier of interest and at least one physical indicia identifier match one another.

Accordingly, and consistent with one or more aspects of the present invention, the transmitting step (i.e., step 418) may include integrating into the acquired electronic file 112 of the digital reproduction of the original entity 108 a digital representation of a result indicative of whether the compared at least one physical indicia identifier of interest and at least one physical indicia identifier match one another.

Accordingly, and consistent with one or more aspects of the present invention, the receiving step (i.e., step 420) may include receiving, by the customer computer 126, from the server computer system 104 the digital reproduction of the at least one portion of the original entity 108 associated with acquired electronic file 110 into which the digital representation of the result indicative of whether the compared at least one physical indicia identifier of interest and at least one physical indicia identifier match one another is integrated.

Accordingly, and consistent with one or more aspects of the present invention, the outputting step (i.e., step 422) may include outputting, by the customer computer 126, on the outputting unit 130 of the customer computer 126 the digital representation of the result indicative of whether the compared at least one physical indicia identifier of interest and at least one physical indicia identifier match one another.

In one embodiment, and consistent with one or more aspects of the present invention, the obtaining step (i.e., step 200) may include scanning, by an image scanning apparatus operatively coupled to the publisher computer 102, the at least one portion of the original entity 108 on which the at least one physical indicia identifier 108-a is appearing to obtain the digital reproduction of the at least one portion of the original entity 108 on which the at least one physical indicia identifier 108-a is appearing.

In one embodiment, and consistent with one or more aspects of the present invention, the obtaining step (i.e., step 200) may include capturing, by an image capturing apparatus operatively coupled to the publisher computer 102, the at least one portion of the original entity 108 on which the at least one physical indicia identifier 108-a is appearing to obtain the digital reproduction of the at least one portion of the original entity 108 on which the at least one physical indicia identifier 108-a is appearing.

As illustrated in FIG. 5, the machine-readable data 500 may be formed adjacent the set of unique identifiers 108-c on the any portion of the document type of original entity 108, and may be in the form of a barcode. The document type of entity 108 may be a digital copy or a physical print-out. It is to be understood and appreciated, however, that the machine-readable data 500 may also be in the form of a quick-response code, an NFC (Near Field Communications) tag, an RFID (Radio Frequency Identification) tag, and/or any suitable or preferred combinations thereof.

Still in FIG. 5, it is illustrated that the set of unique of identifiers 108-c may undergo a verification process 502. In one embodiment, the set of unique of identifiers 108-c may be verified online 504 through an online verification process 502 in accordance with aspects of the present invention. On the other hand, the machine-readable data 500 may be verified offline 506 through an offline verification process and, as such, using any offline data reading apparatus such as a barcode reader disposed in any location in relation to any given computer terminal.

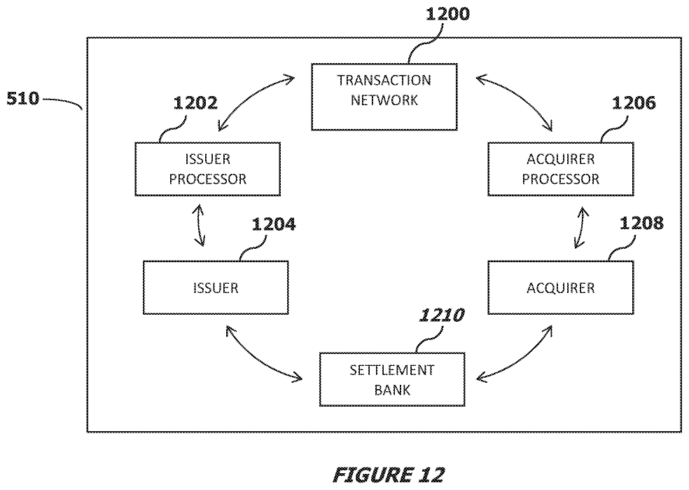

Still in FIG. 5, and in one embodiment, the verification process 502 may come with a fee or set of fees which can be settled through a payment processing operation 508. The payment processing operation 508 may be initiated and completed in any suitable payment network 510. In FIG. 12, there is shown a block diagram which illustrates exemplary components of such payment network 510 which may be suitable for use in implementing transformation of the original entity 108 into a verifiably authenticable entity in accordance with any one or more of the herein aspects of the present invention.

Now in FIG. 12, the payment network 510 may include a transaction network 1200 which connects an issuer processor 1202 associated with an issuer 1204 and an acquirer processor 1206 associated with an acquirer 1208. The example payment network 510 may also include a settlement bank 1210. It is to be understood and appreciated that these components, and as well as their communication arrangements, which are associated with the payment network 510, are merely exemplary for the purpose of illustrating the manner by which transactions can be carried out according to one or more aspect of the present invention, and that the same components and their communication arrangements may vary depending on the type and nature of the financial transactions involved (e.g., credit or debit type of financial transactions).

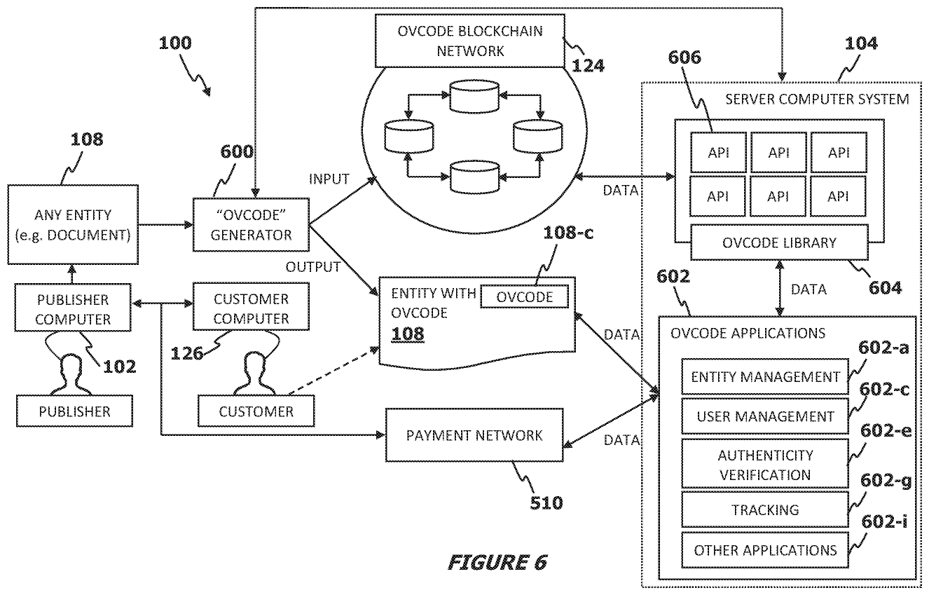

Referring to FIG. 6, there is shown a detailed block diagram, or a network diagram in particular, which illustrates exemplary components of the system 100 for implementing transformation of the original entity 108 into a verifiably authenticable entity consistent with one or more aspects of the present invention. The customer may use his or her publisher computer 102, such as a laptop computer, to access either a web or mobile based software application and accordingly cause generation of the set of unique identifiers or “SUI” or “OVNumber” or “OVCode” 108-c by the “OVNumber” generator 600 and to further cause the generated set of unique identifiers 108-c to be published as an input data to the OVNumber Blockchain network 124 over any suitable data network 106 such as the Internet.

Consequently, the set of unique identifiers 108-c may be caused by the publisher, using a printer coupled to his or her publisher computer 102 for example, to be printed on the upper right portion of the document type of entity 108. The publisher computer 102 may be connected to the payment network 510 for processing of payment of any prescribed or chargeable fees associated with the performance of the electronic transaction characterized by the generation of the set of unique identifiers 108-c and its publication on the OVNumber Blockchain network 124 over any suitable data network 106 such as the Internet.

On the other hand, a customer may use his or her customer computer 126, which may also be a laptop computer, to web or mobile based software application and accordingly cause the performance of verification of the authenticity of the set of unique identifiers 108-c relative to the document type of document 108. In some embodiments, and consistent with one or more aspects of the present invention, the herein disclosed physical indicia identifier 108-a may be the at least one portion or the entire portion of the original entity 108, such as the document type of entity 108, itself.

The customer computer 126 may be connected to the payment network 510 for processing of payment of any chargeable fees associated with the performance of the electronic transaction characterized by the online verification of the authenticity of the set of unique identifiers 108-c relative to the document type of entity 108 over any suitable data network 106 such as the Internet.

In various embodiments, the server computer system 104 may include and execute a number of verification-related applications 602 which may include an entity management application 602-a for managing the data and data structures associated with the electronic record 112 of the original entity 108, a user management application 602-c for managing user accounts which may be associated with publishers and customers, an authenticity verification application 602-e for managing verification procedures and processes associated with one or more aspects of the present invention, a tracking application 602-g for managing location and position information which may be associated with the original entity 108, and other applications 602-i which may be customizably designed to support the operations and procedures embodied in the present invention.

The server computer system 104 may also include a library 604 of the set of unique identifiers or “OVCODES” 108-c which can be accessed through different APIs (application programming interfaces) 606. These APIs can be used to cause sharing with the Blockchain network 124 of data associated with the application 602 and as well as with the set of unique identifiers 108-c.

In some embodiments, and consistent with one or more aspects of the present invention, the server computer system 104 may include a digital wallet application (not illustrated in the drawings) which may be arranged to generate and maintain a digital wallet. The digital wallet may be assigned to each user operating the publisher computer 102. It is preferable that all sets of the unique identifiers 108-c, which are individually associated with a number of the original entities 108 owned by each user operating the publisher computer 102, may be stored in the digital wallet in a customizable and/or organizable manner. Much like a physical keychain, the digital wallet may used by each user of the publisher computer 102 to store and manage information associated with his or her registered entities 108. This digital wallet may also be arranged such that it can carry electronic transactions such as the herein disclosed electronic verification and/or authentication related transactions and all associated data. Use of this digital wallet comes with the advantage of maintaining said information and data without having to print them out.

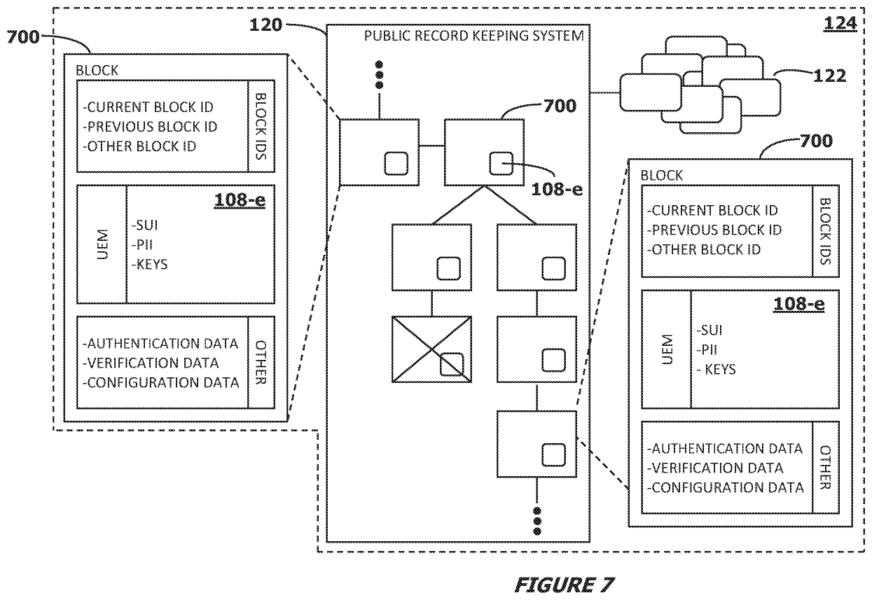

Referring to FIG. 7, there is shown a block diagram which illustrates exemplary components of the public record keeping system 120 located in the decentralized computational network 124 which can be used for implementing transformation of the original entity 108 into a verifiably authenticable entity consistent with one or more aspects of the present invention. The public record keeping system 120 mainly comprises the nodes 122 which may reside in the decentralized computational network 124.

Consistent with any one or more of the herein disclosed aspects of the present invention, the decentralized computational network 124 may be a distributed peer-to-peer network 124 such as a Blockchain network 124. Accordingly, and still consistent with any one or more of the herein disclosed aspects of the present invention, the decentralized computational network protocol associated with the decentralized computational network 124 may be a peer-to-peer network protocol such as a Blockchain protocol.

The distributed record keeping procedures and data structure which may constitute the public record keeping system 120 may be of secure type and distributed among the nodes 122 in the peer-to-peer network 124, wherein a common set of procedures are followed by the participating nodes 122 in order to mitigate any uncertainties, risks and distrust which may arise between two of the nodes 122 or among three or more of the nodes 122 in the decentralized computational network 124.

Since the nodes 122 are likely not affiliated with one another, may be located remotely in respect of one another across the entire world, and may be used to perform electronic transactions, such as the herein disclosed electronic verification and authentication transactions, in the peer-to-peer network 124 in an anonymous manner, security of the publishers of the uniquely encrypted messages 108-e and the customers performing the electronic transactions, in general terms, is guaranteed.

Owing to the public nature of the public record keeping system 120, each of the anonymous nodes 122 may be able to monitor the movement and/or change in the data published on the public records within the public record keeping system 120 such as data associated with the herein disclosed uniquely encrypted message 108-e, transparency is maintained at the peer-to-peer network 124. This transparency, as may be highlighted in the herein disclosure, substantially mitigates any uncertainties, risks and distrust that may occur among the nodes 122.

The distributed records which may constitute the public record keeping system 120 may be maintained by the nodes 122 in a collective manner within the peer-to-peer network 124 which is a secure distributed network. Hence, these publicly distributed records are secure decentralized distributed records or transaction records which are otherwise known as the aforementioned Blockchain. The public record keeping system 120, in this regard, may be decentralized and based on Blockchain-based technological framework and platforms. The Blockchain may include various blocks 700 which are linked to one another and which may carry uniquely encrypted messages 108-e. These messages 108-e can be validated through the public record keeping system 120.

In some embodiments, the Blockchain may be used to enable the nodes 122 in the peer-to-peer network 124 to communicate with one another in respect of electronic transactions which may be verification and authentication transactions. These communications, along with electronic exchanges of the uniquely encrypted messages 108-e among the nodes 122 in the peer-to-peer network 124 through the public record keeping system 120, come with technical advantages and benefits.

Firstly, the uniquely encrypted messages 108-e, which are individually and may be uniquely associated with the blocks 700, can be freely transmitted from any one of the nodes 122 to another one of the nodes 122, from any one of the nodes 122 to any two or more of the nodes 122, and from any two or more of the nodes 122 to any one of the nodes 122; hence, transparency of the herein disclosed verification and authentication transactions, among other possible accompanying transactions in accordance with one or more aspects of the present invention, is guaranteed.

Secondly, the uniquely encrypted messages 108-e are not governed by a central authority framework which can be used to maliciously alter the data, data structure, or content associated with one or more of the distributed records within the public record keeping system 120 including the data, data structure, or content associated with the uniquely encrypted messages 108-e. In addition, the digital signature including the private key 118 used to encrypt the data changes along with any change effected against any portion, such as the string of characters, of the same data.

Thirdly, no one of the blocks 122 carrying the uniquely encrypted messages 108-e can be altered, obliterated, obfuscated or removed without knowing the unique pair of but different public keys 116 and private keys 118 used to encrypt the physical indicia identifier 108-a and/or the set of unique identifiers 108-c associated with the electronic record 112 using any well-known cryptography-based operation, procedure, and/or method in whatsoever manner thereby substantially reducing, if not completely eliminating, fraudulent events and malicious activities relating to the publication of the uniquely encrypted message 108-e on the chain of data in the publicly distributed record keeping system 120. Effectively, the aspects of the present invention provide for protection of individuals, valuable objects, precious assets, and properties from such malicious activities.

Fourthly, preventing any one or more of the nodes 122 from accessing any one or more of the distributed records in the public record keeping system 120 by another one or more of the nodes 122 is too complex, if not nearly impossible, to perform; hence, any one or more of the nodes 122 can be used to freely, discreetly, and/or privately perform, i.e., without constraints, the herein disclosed verification and authentication transactions.

Lastly, but certainly not of least importance, the posting and exchanging of the uniquely encrypted messages 108-e in the distributed peer-to-peer network 124 can be performed in a scheduled manner or in real-time or near real-time thereby giving the participating nodes 122 the flexibility or resiliency in both operation and management (e.g., later or on-demand retrieval of uniquely encrypted messages 108-e to be used in performing the herein disclosed verification and authentication processes).

In some embodiments, each node 122 of the connected plurality of the nodes 122 in the decentralized computational network 124 is enabled to cross check, verify, and/or authenticate that the uniquely encrypted message 108-e originates from, or is associated with, or authentically belongs, to its true publisher by way of decrypting the uniquely encrypted message 108-e with the public key 116 associated with the publisher computer 102 used by the true publisher to cause the uniquely encrypted message 108-e to be generated and, subsequently, to be published to the chain of data on the public record keeping system 120 in the decentralized computational network 124.

In some embodiments, each node 122 of the connected plurality of the nodes 122 in the decentralized computational network 124 is enabled to cross check, verify, and/or authenticate that the set of unique identifiers of interest and/or the physical indicia identifier of interest carried by the uniquely encrypted message 108-e is published to the chain of data on the public record keeping system 120 by way of decrypting the uniquely encrypted message 108-e with the public key 116 associated with the publisher computer 102 used by the publisher to cause the uniquely encrypted message 108-e associated with the electronic record 112 of the original entity 108 to be published to the chain of data on the public record keeping system 120 in the decentralized computational network 124.

It is in this regard that, and in sum, the provisions of the publishing of the uniquely encrypted message 108-e, which effectively carries the associated set of unique identifiers 108-c and the physical indicia identifier 108-a extracted from the electronic file 110 created by the publisher computer 102 based on the digital reproduction of the portion of the original entity 108, on the public record keeping system 120, and verifying the authenticity of an entity of interest relative to the original entity 108 as a reference point by way of decrypting this uniquely encrypted message 108-e to identify whether the set of unique identifiers of interest associated with the entity of interest is published to the chain of data on the public record keeping system 120 provide for: (i) cross checking by any of the nodes 122 in the Blockchain network 124 that the uniquely encrypted message 108-e is associated with its real publisher which results in the transparency in the ownership of the uniquely encrypted message 108-e and in turn of the original entity 108; and (ii) preservation of integrity of data associated with the uniquely encrypted message 108-e since any single change made against the string of characters in the uniquely encrypted message 108-e on the public record keeping system 120 effectively changes its digital signature and such change, if it would occur, can be easily and speedily detected through the nodes 122 which do not rely on a central repository of data nor on a central server computer system, which usually comes in a significant number, which are distributed across the world via a network of private computers and computer systems, and which may individually possess a copy of the uniquely encrypted message 108-e.

In some embodiments, receiving the uniquely encrypted messages 108-e from or sending the uniquely encrypted messages 108-e to one of the nodes 122 or a plurality of the nodes 122 may be performed using the Blockchain which characterizes the public record keeping system 120. In performing these receiving and sending functions, each one of the blocks 700 containing the uniquely encrypted messages 108-e in the Blockchain may utilize various information which may be include, but certainly not limited to, identifiers associated with the blocks 700 (e.g., current block ID, previous block ID, and other block ID), identifiers associated with the uniquely encrypted messages 108-e (e.g., set of unique identifiers or “SUI” 108-c, physical indicia identifier or “PII” 108-a, public key 116, and private key 118), and other data such as authentication data, verification data, and configuration data. Any one or more of these information may be recorded on, and can be made retrievable on demand from, any one or more of the distributed records within the public record keeping system 120.

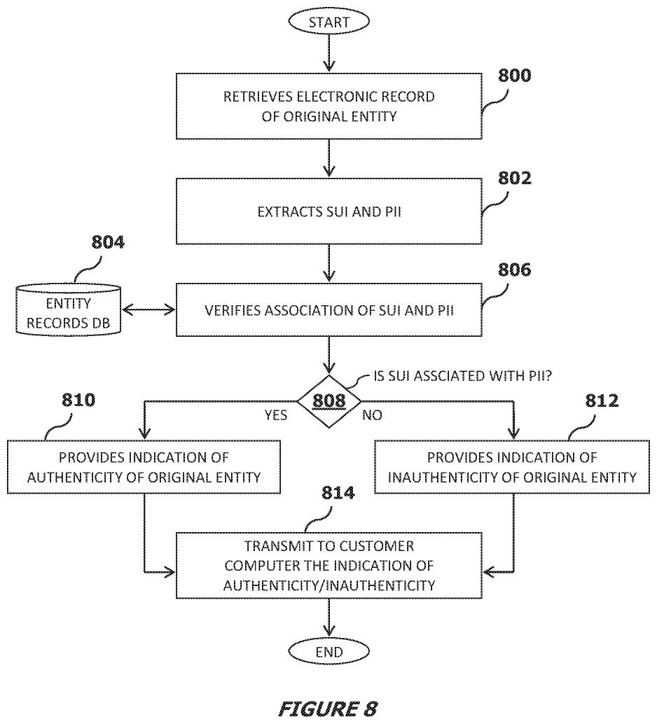

Referring to FIG. 8, there is shown a flow diagram illustrating an example verification process suitable for use in one or more aspects of the present invention. This example verification process may be performed by the herein disclosed server computer system 104. The verification process may start by retrieving the electronic record 112 of the original entity 108 (step 800), and proceed with the extraction of the set of unique identifiers or “SUI” 108-c and the physical indicia identifier or “PII” 108-a from the retrieved electronic record 112 of the original entity 108 (step 802).

Subsequently, the verification process may advance to the step of verifying the association of the set of unique identifiers 108-c and the physical indicia identifier 108-a by consulting an entity records database 804 (step 806), and then to the decision step of determining whether the set of unique identifiers 108-c and the physical indicia identifier 108-a are associated with one another (decision step 808). The entity records database 804 may contain information associated with electronic files 112 which are provided with the set of unique identifiers 108-c.

If the set of unique identifiers 108-c and the physical indicia identifier 108-a are associated with one another, the verification process may advance to the step of providing an indication of authenticity of the original entity 108 (step 810); otherwise, the verification process may advance to the step of providing an indication of inauthenticity of the original entity 108 (step 812). From any of the previous steps 810 and 812, the verification process may conclude by transmitting to the customer computer 126 the indication of the authenticity or inauthenticity of the original entity 108 based on the result in the decision step 808 (step 814).

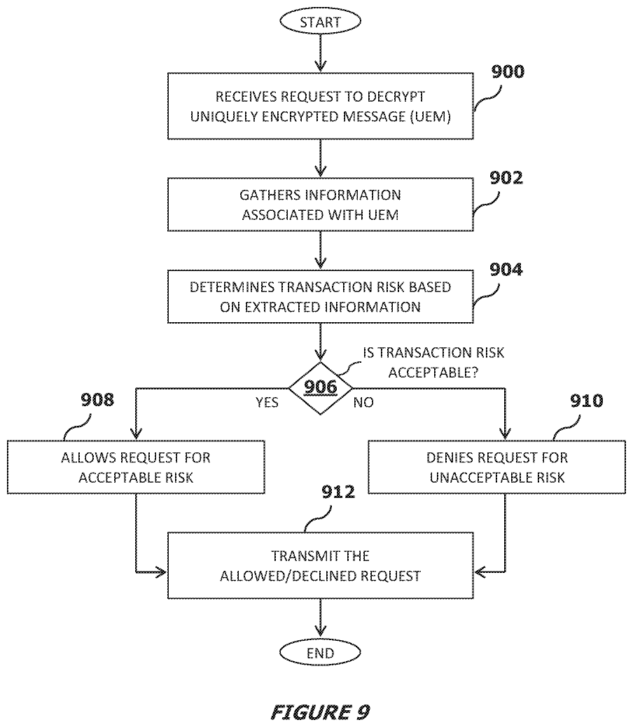

Referring to FIG. 9, there is shown a flow diagram which illustrates an example risk management process suitable for use in one or more aspects of the present invention. The example risk management process may be performed by any of the server computer system 104 and any one of the nodes 122 in the decentralized computational network 124. The risk management process may start by receiving request to decrypt the uniquely encrypted message 108-e (step 900), and continue by gathering information, which may be publicly available information, associated with the uniquely encrypted message 108-e (step 902). These information may refer to the history of the set of unique identifiers 108-c and/or the physical indicia identifier 108-a, whether any of them has already been a subject of fraud in the past.

Once the information associated with the uniquely encrypted message 108-e have been gathered in the previous step 902, the risk management process may proceed to the step of determining transaction risk associated with the request to decrypt the uniquely encrypted message 108-e (step 904) based on the gathered information. If the transaction risk is acceptable as determined in the decision step 906, the risk management process may advance to the step of allowing the request to decrypt the uniquely encrypted message 108-e (step 908); otherwise, if the transaction risk is found to be unacceptable, the risk management process may instead advance to the step of denying the same request (step 910). The risk management process may conclude by transmitting the allowed or otherwise denied request to any requesting computing device over any suitable data network (step 912).

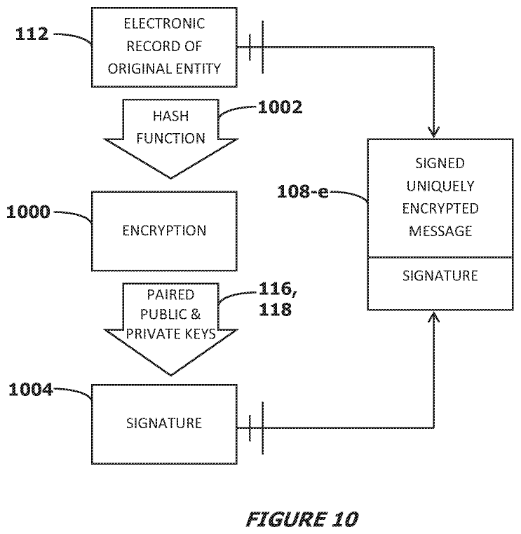

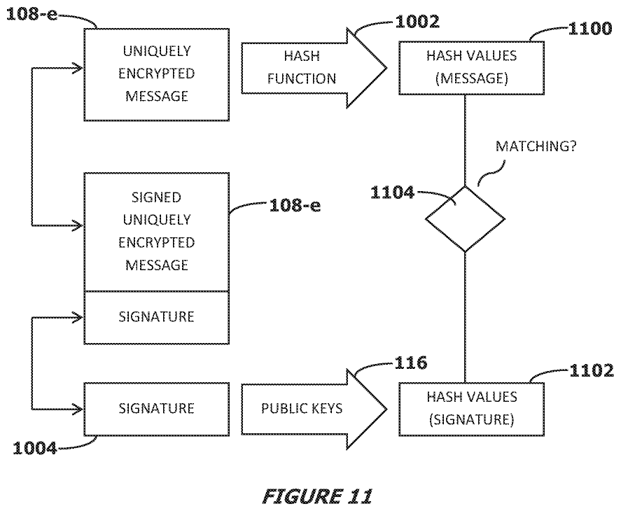

Referring to FIGS. 10 and 11, there are shown high level block diagrams collectively which illustrates an exemplary process for generating and an exemplary process for decrypting the uniquely encrypted message 108-e, respectively, suitable for use in one or more aspects of the present invention. The processes for generating and decrypting the uniquely encrypted message 108-e may be performed by the server computer system 104 in relation to the herein disclosed publisher computer 102 and to the herein disclosed decentralized computational network 124.

As illustrated in FIG. 10 alone, transaction messages in general or the process for generating the uniquely encrypted message 108-e in particular may undergo an encryption process 1000 by way of applying a hash function 1002. In one embodiment, the electronic record 112 of the original entity 108 may be digitally signed by the publisher or the sender of the same the electronic record 112 of the original entity 108 using his or her public and private keys 116, 118 which are associated with his or her publisher computer 102 and which may be paired together. Those skilled in the art shall recognize well-known methods and techniques that can be used to affix the signature 1004 to the electronic record 112 of the original entity 108 for the purpose of utilizing the hash function 1002 and the paired public and private keys 116, 118 in generating the signed uniquely encrypted message 108-e. The signed uniquely encrypted message 108-e, all by itself or alone, ensures integrity of the data which are associated with the electronic record 112 of the original entity 108 which can used as part of the herein disclosed computer-based verification and authentication processes.

In FIG. 11 alone, the process for decrypting the uniquely encrypted message 108-e may be characterized by extracting, using the hash function 1002, a first set of hash values 1100 derived from the uniquely encrypted message 108-e that is digitally signed. Simultaneously, or one after the other, the decrypting process may include, using the public keys 116, a second set of hash values 1102 from the signature 1004 which is derived from the uniquely encrypted message 108-e that is digitally signed. At decision step 1104, the first set of hash values 1100 and the second set of hash values 1102 may be compared with one another to determine if they are matching with one another. A matching set of the hash values 1100, 1102 may provide an indication that the signed uniquely encrypted message 108-e, which carries the set of unique identifiers 108-c and the physical indicia identifier 108-a associated with the original entity 108, is authentically related to electronic record 112 of the original entity 108 used to generate the same signed uniquely encrypted message 108-e. Otherwise, a mismatching set of the hash values 1100, 1102 may provide an indication that the signed uniquely encrypted message 108-e is not authentically related to electronic record 112 of the original entity 108 used to generate the same signed uniquely encrypted message 108-e and, hence, is potentially generated through fraudulent activities.

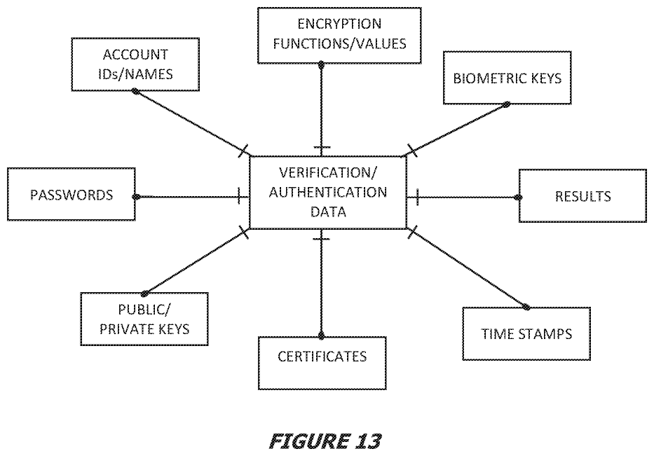

Referring to FIG. 13, there is shown a block diagram which illustrates exemplary information associated with verification and authentication processes suitable for use in implementing transformation of an original entity into a verifiably authenticable entity consistent with one or more aspects of the present invention. These exemplary information associated with such processes may include, by way of examples and not by way of limitation, encryption functions and values, account IDs or names, passwords, public and/or private keys, digital certificates, time stamps, verification/authentication results, and biometric keys.

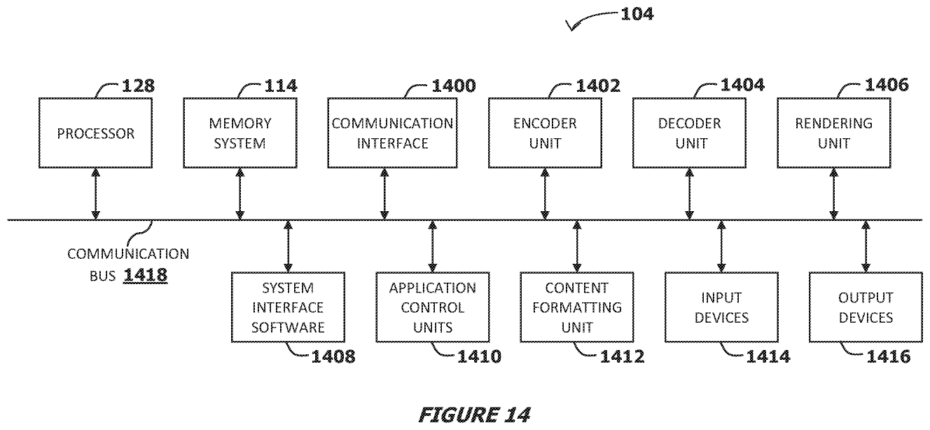

Referring to FIG. 14, there is shown a schematic block diagram which illustrates an exemplary hardware configuration of the server computer system 104 suitable for use in implementing transformation of an original entity into a verifiably authenticable entity consistent with one or more aspects of the present invention. The herein described computer-executable operations, procedures, and/or methods to be performed server computer system 104 may be stored on the memory system 114 and may be fetched and executed from the memory system 114 by the processor 128 of the server computer system 104.

Data associated with the herein described computer-executable operations, procedures, and/or methods associated with the server computer system 104 may be transmitted to another computer or computer system and/or received from another computer or computer system using the communication interface 1400, may be encoded and/or decoded using the encoder and decoder units 1402, 1404, may be displayed through the rendering unit 1406, may be controllably accessed through the system interface software 1408, may be integrated into a software application through the application control units 1410, may be customizably formatted through the content formatting unit 1412, and/or may be manipulated using the input and output devices 1414, 1416. These components may communicate with one another through a communication bus 1418 and/or other well-known circuitry arrangements for a server type of computer system or a server type of network of computer systems.

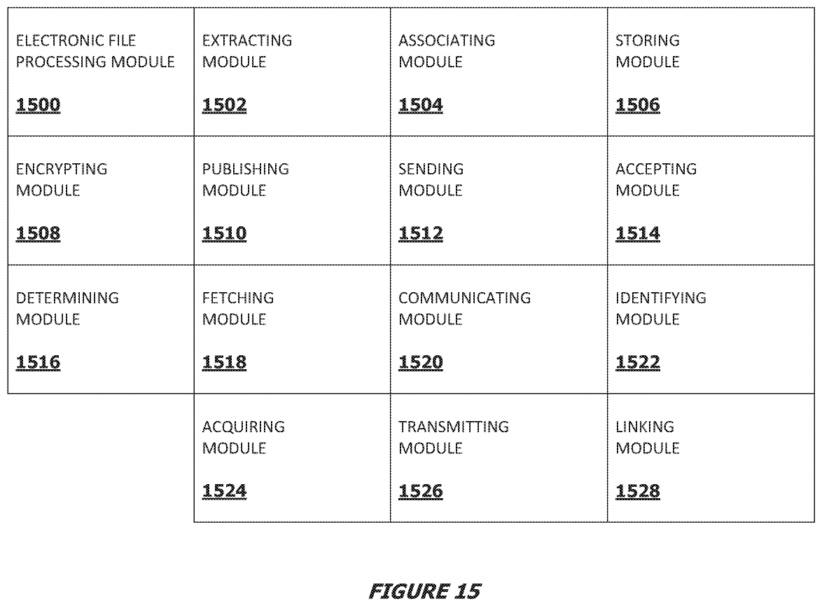

Referring to FIG. 15, there is shown a block diagram which illustrates exemplary computer-based modules of the server computer system 104 suitable for use in implementing transformation of the original entity 108 into a verifiably authenticable entity consistent with one or more aspects of the present invention. In accordance with another aspect of the present invention, the server computer system 104 may be used for implementing transformation of the original entity 108 into a verifiably authenticable entity in a heterogeneous communications network environment, wherein the original entity 108 has at least one physical indicia identifier 108-a appearing thereon, wherein the server computer system 104 is operatively communicating, over the communications network 106, with the publisher computer 102, the customer computer 126, and the decentralized computational network 124.

The server computer system 104 may comprise an electronic file processing module 1500 configured to create the electronic file 110 of the digital reproduction of the at least one portion of the original entity 108 delivered from the publisher computer 102 which obtains the digital reproduction of the at least one portion of the original entity 108 on which the at least one physical indicia identifier 108-a is appearing.

The server computer system 104 may also comprise an extracting module 1502 configured to extract the at least one physical indicia identifier 108-a from the electronic file 110.

The server computer system 104 may also comprise an associating module 1504 configured to associate the set of unique identifiers 108-c to the extracted at least one physical indicia identifier 108-a to create the electronic record 112 of the original entity 108.

The server computer system 104 may also comprise a storing module 1506 configured to store in the memory system 114 of the server computer system 104 the electronic record 112 of the original entity 108 having the associated set of unique identifiers 108-c and at least one physical indicia identifier 108-a.

The server computer system 104 may also comprise an encrypting module 1508 configured to encrypt the electronic record 112 of the original entity 108 using the public key 116 associated with the publisher computer 102 and the digital signature including the private key 118 associated with the publisher computer 102 to generate the uniquely encrypted message 108-e carrying the associated set of unique identifiers 108-c and at least one physical indicia identifier 108-a.

The server computer system 104 may also comprise a publishing module 1510 configured to publish the uniquely encrypted message 108-e to the chain of data on the public record keeping system 120 residing in the one or more nodes 122 in the decentralized computational network 124 using the at least one decentralized computational network protocol.

The server computer system 104 may also comprise a sending module 1512 configured send to the publisher computer 102 the set of unique identifiers 108-c.

In the server computer system 104 aspect of the present invention, the marking apparatus 125 operatively coupled to the publisher computer 102 may be arranged to form the set of unique identifiers 108-c on the any portion of the original entity 108.

Still in the server computer system 104 aspect of the present invention, when the customer computer 126 accesses the server computer system 104 over the communications network 106 whereby a customer operating the customer computer 126 is enabled to verify whether an entity of interest is authentic relative to the original entity 108 as a point of reference, the server computer system is arranged to include and execute the following further modules: (i) an accepting module 1514; (ii) a determining module 1516; (iii) a fetching module 1518; (iv) a communicating module 1520; (v) a identifying module 1522; (vi) an acquiring module 1524; (vii) a transmitting module 1526; and (viii) a linking module 1528.

The accepting module 1514 is preferably configured to accept from the customer computer 126 the set of unique identifiers of interest formed on the entity of interest having at least one physical indicia identifier of interest.

The determining module 1516 is preferably configured to determine whether the set of unique identifiers of interest and the at least one physical indicia identifier of interest are associated with one another and exist in the memory system 114 of the server computer system 104.

The fetching module 1518 is preferably configured to, if the set of unique identifiers of interest and the at least one physical indicia identifier of interest are associated with one another and exist in the memory system 114 of the server computer system 104, fetch from the memory system 114 of the server computer system 104 the electronic record 112 of the original entity 108 corresponding to the associated set of unique identifiers of interest and at least one physical indicia identifier of interest existing in the memory system 114 of the server computer system 104.

The communicating module 1520 is preferably configured to communicate, over the communications network 106, with the decentralized computational network 124 using the at least one decentralized computational network protocol.

The identifying module 1522 is preferably configured to identify, as one of the one or more nodes 122 in the decentralized computational network 124, whether the set of unique identifiers of interest carried by the uniquely encrypted message 108-e is published to the chain of data on the public record keeping system 120 by decrypting the uniquely encrypted message 108-e associated with the fetched electronic record 112 of the original entity 108 using the public key 116 of the publisher computer 102 which causes creation of the fetched electronic record 112 of the original entity 108.

The acquiring module 1524 is preferably configured to, if the at least set of unique identifiers of interest is recorded in the chain of data, acquire from the memory system 114 of the server computer system 104 in whole or in part the electronic file 110 of the digital reproduction of the at least one portion of the original entity 108 based on the associated set of the unique identifiers of interest and physical indicia identifier of interest.

The transmitting module 1526 is preferably configured to transmit, over the communications network 106, to the customer computer 126 the acquired electronic file 110 of the digital reproduction of the at least one portion of the original entity 108.

Consistent with one or more aspects and embodiments of the present invention, the linking module 1528 is preferably configured and/or the server computer system 104 may be further arranged to link a first of the set of unique identifiers 108-c associated with and generated for a first of the original entity 108 to a second of the set of unique identifiers 108-c associated with and generated for the second of the original entity 108.

In the server computer system 104 aspect of the present invention, the customer computer 126 is arranged to receive, over the communications network 106, the transmitted digital reproduction of the at least one portion of the original entity 108 associated with acquired electronic file 110 from the server computer system 104, and subsequently output on the output unit 130 of the customer computer 126 the received digital reproduction of the at least one portion of the original entity 108.

It is to be understood and appreciated that the herein described and illustrated modules associated with the server computer system 104 aspect of the present invention may or may not correspond to discrete blocks of program codes, depending on how they are suitably arranged. In this regard, it can be realized that the functions described for each module can be performed in implementing transformation of the original entity 108 into a verifiably authenticable entity by executing various code portions which are stored on one or more non-transitory computer-readable media and at predetermined time intervals.

It is also to be understood and appreciated that the execution of the program codes from the memory system 114, which may be a non-transitory computer-readable media, can be done on appropriate computing hardware and number of computing hardware, and that the herein described and illustrated modules associated with the server computer system 104 aspect of the present invention are merely segregated based on their intended functions for the sake of illustrating how they are relevant to the implementation of one or more preferred embodiments of any one or more the various aspects of the present invention.

It is also to be understood and appreciated that the herein described and illustrated modules can be fewer or greater in number, as it is well known in the art that program codes representing various functions of different modules can be combined or segregated in any suitable but efficient manner insofar as program execution is concerned.

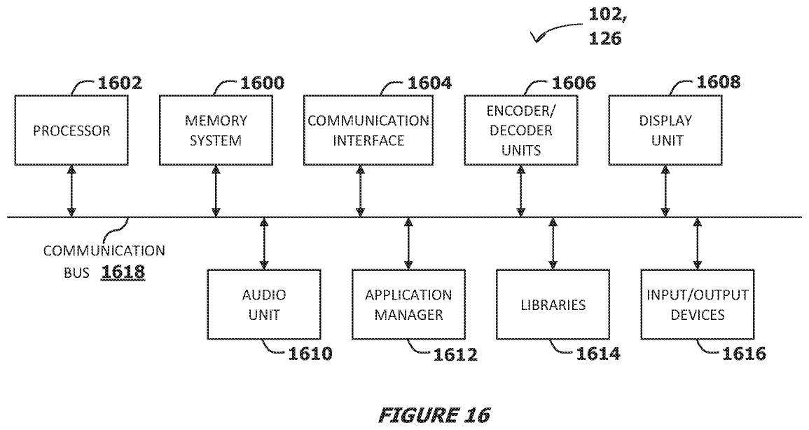

Referring to FIG. 16, there is shown a schematic block diagram which illustrates an exemplary hardware configuration of the publisher computer 102 or the customer computer 126 suitable for use in implementing transformation of the original entity 108 into a verifiably authenticable entity consistent with one or more aspects of the present invention. The herein described computer-executable operations, procedures, and/or methods to be performed by either the publisher computer 102 or the customer computer 126 may be stored on the memory system 1600 and may be fetched and executed from the memory system 1600 by a processor 1602 of the publisher or customer computers 102, 126.

Data associated with the herein described computer-executable operations, procedures, and/or methods associated with the publisher computer 102 or the customer computer 126 may be transmitted to another computer or computer system and/or received from another computer or computer system using the communication interface 1604, may be encoded and/or decoded using the encoder and decoder units 1606, may be displayed through the display unit 1608, may be played as an audio file, if applicable, through the audio unit 1610, may be managed through the application manager 1612 and/or the application libraries 1614, and/or may be manipulated using the input and output devices 1616. Any two or more of these components may communicate with one another through a communication bus 1618 and/or other well-known circuitry arrangements.

While the present invention has been described with respect to a limited number of implementations and/or embodiments, those skilled in the art, having benefit of this disclosure, will appreciate that other implementations and/or embodiments can be devised which do not depart from the scope of the present invention as disclosed herein.

1. A method of implementing transformation of an original entity into a verifiably authenticable entity in a heterogeneous communications network environment, the original entity having at least one physical indicia identifier appearing thereon, the method comprising the steps of:
obtaining, by a publisher computer, a digital reproduction of at least one portion of the original entity on which the at least one physical indicia identifier is appearing;
creating, by the publisher computer, an electronic file of the digital reproduction of the at least one portion of the original entity;
delivering, by the publisher computer in operative communication with a server computer system over a communications network, to the server computer system the electronic file;
extracting, by the server computer system, the at least one physical indicia identifier from the electronic file;
associating, by the server computer system, a set of unique identifiers to the extracted at least one physical indicia identifier to create an electronic record of the original entity;
sending, by the server computer system over the communications network, to the publisher computer the set of unique identifiers; and
forming, by a marking apparatus operatively coupled to the publisher computer, the set of unique identifiers on any portion of the original entity,
wherein the associating step further includes
storing, by the server computer system, in a memory system of the server computer system the electronic record of the original entity having the associated set of unique identifiers and at least one physical indicia identifier,
encrypting, by the server computer system, the electronic record of the original entity using a public key associated with the publisher computer and a digital signature including a private key associated with the publisher computer to generate a uniquely encrypted message carrying the associated set of unique identifiers and at least one physical indicia identifier, and
causing, by the server computer system over the communications network, to be published the uniquely encrypted message to a chain of data on a public record keeping system residing in one or more nodes in a decentralized computational network using at least one decentralized computational network protocol, and
wherein, when a customer computer accesses the server computer system over the communications network whereby a customer operating the customer computer is enabled to verify whether an entity of interest is authentic relative to the original entity as a point of reference, the server computer system performs the steps of
accepting from the customer computer a set of unique identifiers of interest formed on the entity of interest having at least one physical indicia identifier of interest,
determining whether the set of unique identifiers of interest and the at least one physical indicia identifier of interest are associated with one another and exist in the memory system of the server computer system,
if the set of unique identifiers of interest and the at least one physical indicia identifier of interest are associated with one another and exist in the memory system of the server computer system, fetching from the memory system of the server computer system the electronic record of the original entity corresponding to the associated set of unique identifiers of interest and at least one physical indicia identifier of interest existing in the memory system of the server computer system,
communicating, over the communications network, with the decentralized computational network using the at least one decentralized computational network protocol,
identifying, as one of the one or more nodes in the decentralized computational network, whether the set of unique identifiers of interest carried by the uniquely encrypted message is published to the chain of data on the public record keeping system by decrypting the uniquely encrypted message associated with the fetched electronic record of the original entity using the public key associated with the publisher computer which causes creation of the fetched electronic record of the original entity,
if the at least set of unique identifiers of interest is recorded in the chain of data, acquiring from the memory system of the server computer system in whole or in part the electronic file of the digital reproduction of the at least one portion of the original entity based on the associated set of the unique identifiers of interest and physical indicia identifier of interest, and
transmitting, over the communications network, to the customer computer the acquired electronic file of the digital reproduction of the at least one portion of the original entity,
and the customer computer performs the steps of
receiving, over the communications network, the transmitted digital reproduction of the at least one portion of the original entity associated with acquired electronic file from the server computer system, and
outputting on an output unit of the customer computer the received digital reproduction of the at least one portion of the original entity.

2. The method according to claim 1, further comprising the step of linking, by the server computer system, a first of the set of unique identifiers associated with and generated for a first of the original entity to a second of the set of unique identifiers associated with and generated for a second of the original entity.

3. The method according to claim 2, wherein the linking step includes de-linking the first of the set of unique identifiers from the second of the set of unique identifiers.

4. The method according to claim 1, wherein the identifying step includes identifying whether the at least one physical indicia identifier of interest carried by the uniquely encrypted message is published to the chain of data on the public record keeping system by decrypting the uniquely encrypted message associated with the fetched electronic record of the original entity using the public key associated with the publisher computer which causes creation of the fetched electronic record of the original entity.

5. The method according to claim 4, wherein, if the at least one physical indicia identifier of interest is recorded in the chain of data, acquiring from the memory system of the server computer system in whole or in part the electronic file of the digital reproduction of the at least one portion of the original entity based on the associated set of the unique identifiers of interest and physical indicia identifier of interest.

6. The method according to claim 1, wherein, if the set of unique identifiers of interest is recorded in the chain of data, the acquiring step includes comparing the at least one physical indicia identifier of interest with the at least one physical indicia identifier.

7. The method according to claim 6, wherein, if the set of unique identifiers of interest is recorded in the chain of data, the acquiring step includes indicating whether the compared at least one physical indicia identifier of interest and at least one physical indicia identifier match one another.

8. The method according to claim 7, wherein the transmitting step includes integrating into the acquired electronic file of the digital reproduction of the original entity a digital representation of a result indicative of whether the compared at least one physical indicia identifier of interest and at least one physical indicia identifier match one another.

9. The method according to claim 8, wherein the receiving step includes receiving from the server computer system the digital reproduction of the at least one portion of the original entity associated with acquired electronic file into which the digital representation of the result indicative of whether the compared at least one physical indicia identifier of interest and at least one physical indicia identifier match one another is integrated.

10. The method according to claim 9, wherein the outputting step includes outputting on the outputting unit of the customer computer the digital representation of the result indicative of whether the compared at least one physical indicia identifier of interest and at least one physical indicia identifier match one another.

11. The method according to claim 1, wherein the obtaining step includes scanning, by an image scanning apparatus operatively coupled to the publisher computer, the at least one portion of the original entity on which the at least one physical indicia identifier is appearing to obtain the digital reproduction of the at least one portion of the original entity on which the at least one physical indicia identifier is appearing.

12. The method according to claim 1, wherein the obtaining step includes capturing, by an image capturing apparatus operatively coupled to the publisher computer, the at least one portion of the original entity on which the at least one physical indicia identifier is appearing to obtain the digital reproduction of the at least one portion of the original entity on which the at least one physical indicia identifier is appearing.

13. The method according to claim 1, wherein the associating step includes producing, by the server computer system, the set of unique identifiers in a random manner.

14. The method according to claim 13, wherein the randomly produced set of unique numbers are represented by a machine-readable data.

15. The method according to claim 14, wherein the sending step includes sending to the publisher computer the machine-readable data.

16. The method according to claim 15, wherein the forming step includes forming the machine-readable data on the any portion of the original entity.

17. The method according to claim 16, wherein the machine-readable data is formed adjacent the set of unique identifiers on the any portion of the original entity.

18. The method according to claim 14, wherein the machine-readable data are in the form of any of a barcode, a quick-response code, an NFC (Near Field Communications) tag, and an RFID (Radio Frequency Identification) tag.

19. The method according to claim 1, wherein the forming step includes securing, by the marking apparatus, at least one computer-executable marking instruction from the publisher computer.

20. The method according to claim 19, wherein the marking apparatus is any of a 2D (two-dimensional) printing apparatus, a 3D (three-dimensional) printing apparatus, a punch press apparatus, a laser processing apparatus, an ultra violet laser marking apparatus, a plasma processing apparatus, a label applying apparatus, a screen printing apparatus, an etching apparatus, a cutting apparatus, a stamping apparatus, a pad printing apparatus, an engraving apparatus, a grinding apparatus, an annealing apparatus, a casting apparatus, a microdot marking apparatus, a chemical based marking apparatus, a nanotechnology-based marking apparatus, a DNA (deoxyribonucleic acid) forensic marking apparatus, and a biometric information based marking apparatus.

21. The method according to claim 1, wherein the decentralized computational network is a distributed peer-to-peer network.

22. The method according to claim 21, wherein the distributed peer-to-peer network is a Blockchain network.

23. The method according to claim 1, wherein the at least one decentralized computational network protocol is a peer-to-peer network protocol.

24. The method according to claim 23, wherein the peer-to-peer network protocol is a Blockchain protocol.

25. The method according to claim 1, wherein the at least one physical indicia identifier is the at least one portion of the original entity itself.

26. The method according to claim 1, wherein the entity is any of a physical object, a digital object, a human, a microscopic organism, a genetic sequence, a physical structure in an environment, an animal, a plant, a tangible asset, a physical characterization of a tangible asset, a physical characterization of an intangible asset, and a celestial body.

27. A system for implementing transformation of an original entity into a verifiably authenticable entity in a heterogeneous communications network environment, the original entity having at least one physical indicia identifier appearing thereon, the system comprising:
a publisher computer in operative communication with a server computer system over a communications network and arranged to
obtain a digital reproduction of at least one portion of the original entity on which the at least one physical indicia identifier is appearing,
create an electronic file of the digital reproduction of the at least one portion of the original entity, and
deliver, over the communications network, to the server computer system the electronic file;
the server computer system arranged to
extract the at least one physical indicia identifier from the electronic file,
associate a set of unique identifiers to the extracted at least one physical indicia identifier to create an electronic record of the original entity,
store in a memory system of the server computer system the electronic record of the original entity having the associated set of unique identifiers and at least one physical indicia identifier,
encrypt the electronic record of the original entity using a public key associated with the publisher computer and a digital signature including a private key associated with the publisher computer to generate a uniquely encrypted message carrying the associated set of unique identifiers and at least one physical indicia identifier,
cause, over the communications network, to be published the uniquely encrypted message to a chain of data on a public record keeping system residing in one or more nodes in a decentralized computational network using at least one decentralized computational network protocol, and
send, over the communications network, to the publisher computer the set of unique identifiers;
a marking apparatus operatively coupled to the publisher computer and arranged to form the set of unique identifiers on any portion of the original entity; and
a customer computer accessing the server computer system over the communications network whereby a customer operating the customer computer is enabled to verify whether an entity of interest is authentic relative to the original entity as a point of reference,
wherein the server computer system is further arranged to
accept from the customer computer a set of unique identifiers of interest formed on the entity of interest having at least one physical indicia identifier of interest,
determine whether the set of unique identifiers of interest and the at least one physical indicia identifier of interest are associated with one another and exist in the memory system of the server computer system,
if the set of unique identifiers of interest and the at least one physical indicia identifier of interest are associated with one another and exist in the memory system of the server computer system, fetch from the memory system of the server computer system the electronic record of the original entity corresponding to the associated set of unique identifiers of interest and at least one physical indicia identifier of interest existing in the memory system of the server computer system,
communicate, over the communications network, with the decentralized computational network using the at least one decentralized computational network protocol,
identify, as one of the one or more nodes in the decentralized computational network, whether the set of unique identifiers of interest carried by the uniquely encrypted message is published to the chain of data on the public record keeping system by decrypting the uniquely encrypted message associated with the fetched electronic record of the original entity using the public key associated with the publisher computer which causes creation of the fetched electronic record of the original entity,
if the at least set of unique identifiers of interest is recorded in the chain of data, acquire from the memory system of the server computer system in whole or in part the electronic file of the digital reproduction of the at least one portion of the original entity based on the associated set of the unique identifiers of interest and physical indicia identifier of interest, and
transmit, over the communications network, to the customer computer the acquired electronic file of the digital reproduction of the at least one portion of the original entity, and
wherein the customer computer is further arranged to
receive, over the communications network, the transmitted digital reproduction of the at least one portion of the original entity associated with acquired electronic file from the server computer system, and
output on an output unit of the customer computer the received digital reproduction of the at least one portion of the original entity.

28. The system according to claim 27, wherein the server computer system is further arranged to link a first of the set of unique identifiers associated with and generated for a first of the original entity to a second set of the unique identifiers associated with and generated for a second of the original entity.

29. The system according to claim 27, wherein the set of unique identifiers are produced by the server computer system in a random manner.

30. The system according to claim 29, wherein the randomly produced set of unique numbers are represented by a machine-readable data.

31. The system according to claim 30, wherein the machine-readable data is sent, over the communications network, from the server computer system to the publisher computer the machine-readable data.

32. The system according to claim 31, wherein the machine-readable data is formed, by the marking apparatus, on the any portion of the original entity.

33. The system according to claim 32, wherein the machine-readable data is formed adjacent the set of unique identifiers on the any portion of the original entity.

34. The system according to claim 30, wherein the machine-readable data are in the form of any of a barcode, a quick-response code, an NFC (Near Field Communications) tag, and an RFID (Radio Frequency Identification) tag.

35. The system according to claim 27, wherein at least one computer-executable marking instruction is secured by the marking apparatus from the publisher computer.

36. The system according to claim 35, wherein the marking apparatus is any of a 2D (two-dimensional) printing apparatus, a 3D (three-dimensional) printing apparatus, a punch press apparatus, a laser processing apparatus, an ultra violet laser marking apparatus, a plasma processing apparatus, a label applying apparatus, a screen printing apparatus, an etching apparatus, a cutting apparatus, a stamping apparatus, a pad printing apparatus, an engraving apparatus, a grinding apparatus, an annealing apparatus, a casting apparatus, a microdot marking apparatus, a chemical based marking apparatus, a nanotechnology-based marking apparatus, a DNA (deoxyribonucleic acid) forensic marking apparatus, and a biometric information based marking apparatus.

37. The system according to claim 27, wherein the decentralized computational network is a distributed peer-to-peer network.

38. The system according to claim 37, wherein the distributed peer-to-peer network is a Blockchain network.

39. The system according to claim 27, wherein the at least one decentralized computational network protocol is a peer-to-peer network protocol.

40. The system according to claim 39, wherein the peer-to-peer network protocol is a Blockchain protocol.

41. The system according to claim 27, wherein the at least one physical indicia identifier is the at least one portion of the original entity itself.

42. The system according to claim 27, wherein the entity is any of a physical object, a digital object, a human, a microscopic organism, a genetic sequence, a physical structure in an environment, an animal, a plant, a tangible asset, a physical characterization of a tangible asset, a physical characterization of an intangible asset, and a celestial body.

43. A server computer system for implementing transformation of an original entity into a verifiably authenticable entity in a heterogeneous communications network environment, the original entity having at least one physical indicia identifier appearing thereon, the server computer system operatively communicating, over a communications network, with a publisher computer, a customer computer, and a decentralized computational network, the server computer system comprising:
an electronic file processing module configured to create an electronic file of a digital reproduction of at least one portion of the original entity delivered from the publisher computer which obtains the digital reproduction of the at least one portion of the original entity on which the at least one physical indicia identifier is appearing;
an extracting module configured to extract the at least one physical indicia identifier from the electronic file;
an associating module configured to associate a set of unique identifiers to the extracted at least one physical indicia identifier to create an electronic record of the original entity;
a storing module configured to store in a memory system of the server computer system the electronic record of the original entity having the associated set of unique identifiers and at least one physical indicia identifier;
an encrypting module configured to encrypt the electronic record of the original entity using a public key associated with the publisher computer and a digital signature including a private key associated with the publisher computer to generate a uniquely encrypted message carrying the associated set of unique identifiers and at least one physical indicia identifier;
a publishing module configured to cause to be published the uniquely encrypted message to a chain of data on a public record keeping system residing in one or more nodes in a decentralized computational network using at least one decentralized computational network protocol; and
a sending module configured send to the publisher computer the set of unique identifiers,
wherein a marking apparatus operatively coupled to the publisher computer is arranged to form the set of unique identifiers on any portion of the original entity,
wherein, when a customer computer accesses the server computer system over the communications network whereby a customer operating the customer computer is enabled to verify whether an entity of interest is authentic relative to the original entity as a point of reference, the server computer system is arranged to further include
an accepting module configured to accept from the customer computer a set of unique identifiers of interest formed on the entity of interest having at least one physical indicia identifier of interest,
a determining module configured to determine whether the set of unique identifiers of interest and the at least one physical indicia identifier of interest are associated with one another and exist in the memory system of the server computer system,
a fetching module configured to, if the set of unique identifiers of interest and the at least one physical indicia identifier of interest are associated with one another and exist in the memory system of the server computer system, fetch from the memory system of the server computer system the electronic record of the original entity corresponding to the associated set of unique identifiers of interest and at least one physical indicia identifier of interest existing in the memory system of the server computer system,
a communicating module configured to communicate, over the communications network, with the decentralized computational network using the at least one decentralized computational network protocol,
an identifying module configured to identify, as one of the one or more nodes in the decentralized computational network, whether the set of unique identifiers of interest carried by the uniquely encrypted message is published to the chain of data on the public record keeping system by decrypting the uniquely encrypted message associated with the fetched electronic record of the original entity using the public key associated with the publisher computer which causes creation of the fetched electronic record of the original entity,
an acquiring module configured to, if the at least set of unique identifiers of interest is recorded in the chain of data, acquire from the memory system of the server computer system in whole or in part the electronic file of the digital reproduction of the at least one portion of the original entity based on the associated set of the unique identifiers of interest and physical indicia identifier of interest, and
a transmitting module configured to transmit, over the communications network, to the customer computer the acquired electronic file of the digital reproduction of the at least one portion of the original entity, and
wherein the customer computer is arranged to receive, over the communications network, the transmitted digital reproduction of the at least one portion of the original entity associated with acquired electronic file from the server computer system, and output on an output unit of the customer computer the received digital reproduction of the at least one portion of the original entity.
